(19) United States
(12) Patent Application Publication
(10) Pub. No.: US 2017/0302438 A1
(43) Pub. Date: Oct. 19, 2017

(54) ADVANCED BUS ARCHITECTURE FOR AES-ENCRYPTED HIGH-PERFORMANCE INTERNET-OF-THINGS (IOT) EMBEDDED SYSTEMS

(71) Applicants: Xiaokun Yang, Miami, FL (US); Jean H. Andrian, Miami, FL (US)

(72) Inventors: Xiaokun Yang, Miami, FL (US); Jean H. Andrian, Miami, FL (US)

(73) Assignee: The Florida International University Board of Trustees, Miami, FL (US)

(21) Appl. No.: 15/130,298

(22) Filed: Apr. 15, 2016

(51) Int. Cl. H04L 9/06; G06F 13/28; G06F 13/364; G06F 13/42

(52) U.S. Cl. CPC H04L 9/0631; G06F 13/4282; G06F 13/28; G06F 13/364

(57) ABSTRACT

Methods and systems of AES-centric bus architectures and AES-centric state transfer modes are provided. The bus architecture may be implemented on system-on-chip (SoC) devices in conjunction with existing intellectual property (IP) cores. The bus architecture can include a control-bus with a single master, such as a microprocessor, and a data-bus with a single slave, such as DMA.

### BACKGROUND

The world is undergoing a dramatic transformation, rapidly transitioning from isolated systems to ubiquitous Internet-connected things capable of generating data that can be analyzed to extract valuable information. Commonly referred to as the Internet-of-Things (IoT), this new reality will enrich everyday life and increase business productivity. IoT represents a major departure in the history of Internet, as connections move beyond computing devices and begin to power billions of everyday devices, such as Apple Watch, Google Glass, Fitbit devices, Philips smart lights, and Nike wristband. Cisco's Internet Business Solutions Group predicts that the world will have over 50 billion connected devices by 2020. Hardware applications of this kind are essentially all-in-one chips that include data processing, wireless communications, and other functionality all onboard. Therefore, in the near future, hundreds of billions of small-scale, high-speed, and low-power embedded chips intended for use in IoT devices will be necessary.

Concerns about cyberattacks and data privacy have made security a de facto requirement of internet-connected devices. In order to protect data communications in networked devices, several cryptographic algorithms are widely used in hardware today. However, robust and safe cryptographic algorithms can be costly to compute, representing an opposing design goal to the low-cost, low-power embedded chips desirable for IoT devices. As IoT advances, the gap between low-cost chip performance and security algorithm complexity widens.

The Advanced Encryption Standard (AES), issued by the US National Institute of Standards and Technology (NIST) in 2011, is the dominant symmetric-key cryptosystem. Mathematically, AES operates on a 4×4 column-major order matrix of bytes, termed the “state”. Each state is performed by 10, 12, or 14 rounds of transformations with key lengths equal to 128, 192, or 256 bits, respectively. In each round, except for the final round, four transformations, including SubBytes (SB or S-Box), ShiftRows (SR), MixColumns (MC), and AddRoundKeys (AK) are performed for encryption, while InvSubBytes (ISB), InvShiftRows (ISR), InvMixColumns (IMC), and AK are performed for decryption. Among the transformations in AES encryption/decryption, the SB/ISB transformation is a non-linear operation requiring the highest area and consuming substantial processing power and energy.

Some of the earlier SB/ISB implementations are based on look-up table (LUT), such as those described in [5], [6], and [7]. The strict atomicity requirements of accessing the LUT can limit the use of high-efficiency techniques, e.g., parallel computation and pipeline operations. Thus, an alternative composite field method for the S-Box computation has been suggested in [8]. Based on this finite field arithmetic, high-performance implementations are proposed to replace the LUT-based S-Box transformations by combinational logics [9], [10], [11], [12], and [13]. Moreover, [14] and [15] analyze and compare the complexity of the S-Box implementation using different irreducible polynomials. Additionally, AES performance is considered on the core structural level in [16], [17], [18], [19], [20], and [21]. For instance, the four primitive transformations are decomposed, rearranged, and regrouped as new linear and non-linear operations in [16] to provide 1.28 Gbps (0.16 GBps) throughput for 128-bit keys. In [17], the transformations A/IA, SR/ISR, and MC/IMC are combined into a single function unit A/SR/MC or IMC/ISR/IA, and the substructure sharing algorithm is applied to reduce the area cost.

Previous attempts to optimize AES-encrypted chips have predominantly refined the AES cores rather than the AES system as a whole; while refining the cores is useful, changes to bus architectures are at least as important to transfer efficiency and energy consumption.

### BRIEF SUMMARY

Previous AES research was based on the assumption that AES states can be immediately input, column-by-column, into an encrypter (ENC)/decrypter (DEC) engine. However, transferring data by shifted/inverse-shifted block (SB/ISB) in the column-major order using traditional bus architectures incurs substantial bus protocol overhead. Traditional bus architectures, such as the AMBA Advanced High-Performance Bus (AHB) [22] and Advanced eXtensible Interface (AXI) from ARM Holdings [23], Wishbone from Silicore Corporation [24], OCP from OCP-IP [25], CoreConnect from IBM [26], STBus from STMicroelectronics [27], and MSBUS proposed in [28] and [29] process data in the row-major order and are very low-efficiency to supply the rectangular array of bytes required for AES.

To solve these problems, techniques and systems of the subject invention provide an AES-centric bus architecture and an AES-centric state transfer mode. The bus architecture may be implemented, for example, on system-on-chip (SoC) devices in conjunction with existing intellectual property (IP) cores. Embodying SoC devices can be used as components in IoT devices. The bus architecture may be known herein as CDBUS. CBUS can refer to control-bus with a single master, such as a microprocessor, and DBUS can refer to data-bus with a single slave, such as DBUS direct memory access (DMA) connected with an AES encryption/decryption (ENC/DEC) engine and memory.

Synthesizable CDBUS-based designs of the subject invention can include high-performance DMA, AES-encrypted encryption/decryption engines, and several bus protocol wrappers. They can be used as industrial IPs.

From the system point of view, the bus architecture plays a pivotal role in advancing AES-encrypted circuits and, by extension, IoT chip performance. According to embodiments of the subject invention, the resource costs are reduced by the compact dual-bus structure, high degree of parallelism, and the large number of pipeline stages; the valid data bandwidth is increased by the high maximum operating frequency (MOF) of the whole system and the high-efficient bus protocol; and the energy consumption is lowered by the least gate count, and the very low toggle rates of design logics, signals, and IOs.

In some embodiments, an AES state transfer mode utilizes the full pipeline and maximum overlapping AES cores of the CDBUS architecture. Some further embodiments may use composite field arithmetic.

Certain embodiments of the subject invention include an AES-centric DMA supporting AES data exchange on the CDBUS between SoC IPs and memory. The CDBUS-based DMA may include dynamic request arbitration, command pre-processing, and the capability to handle multiple transfer modes. Advantageously, the CDBUS-based DMA may be provided as an IP core for use in SoCs.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows a component diagram with an example 32-bit AES system structure including ENC and DEC engines.

FIG. 2 shows an example of components arranged in an AES-based bus (CDBUS) architecture.

FIGS. 3A-3C show examples of memory access for the DBUS transfer modes.

FIGS. 4A-4C show an example timing diagram and write/read data examples for a 64-bit linear transfer mode.

FIGS. 5A-5C show an example timing diagram and write/read data examples for a 64-bit block transfer mode.

FIGS. 6A-6C show an example timing diagram and write/read data examples for an AES state transfer mode.

FIGS. 7A-7C show non-cipher and cipher test results for the CY metric in AXI versus CDBUS tests.

FIGS. 8A-8C show the pipeline structures and resource costs depending on different bus widths.

FIG. 9 shows an example component diagram depicting an overall DBUS structure, exemplary CDDMA structure, and interconnections with a memory controller and other memory system components.

FIG. 10 shows an example UVM-based verification environment with a CDBUS architecture, CDDMA, and other components.

FIG. 11 shows the ratios of experimental performance metrics for the linear transfers.

FIG. 12 shows the ratios of experimental performance metrics for the block transfers.

FIG. 13 shows the ratios of experimental performance metrics for the cipher transfers.

### DETAILED DESCRIPTION

Methods and systems of the subject invention provide AES-centric bus architectures and AES-centric state transfer modes. The bus architecture may be implemented, for example, on system-on-chip (SoC) devices in conjunction with existing intellectual property (IP) cores. Embodying SoC devices can be used as components in IoT devices. The bus architecture may be known herein as CDBUS. CBUS can refer to control-bus with a single master, such as a microprocessor, and DBUS can refer to data-bus with a single slave, such as DBUS DMA connected with an AES encryption/decryption (ENC/DEC) engine and memory. CDBUS architecture can incorporate CBUS and DBUS. The advanced bus architecture (CDBUS) for the AES encrypted IoT embedded systems can improve IoT chip performance and capabilities, thereby providing efficient architectural support for AES algorithms. Advantages of the CDBUS protocol of the subject invention include, but are not necessarily limited to: 1) very compact dual-bus structure; 2) low-cost and low-power control bus (CBUS), with the reduced and shared interface, half-duplex mode, SINGLE transfer type, and un-pipelined protocol; 3) high-throughput data bus (DBUS), with two novel block and AES state transfer modes, and the existing linear mode backward supported as well; 4) high-efficient DMA residing on DBUS, with dynamic request-arbitration and command pre-processing scheme definition; and 5) high-performance AES ENC/DEC engine residing on DBUS, with specific AES state transfer mode, provided by CDBUS only, and the composite field arithmetic usage.

Related art on-chip bus protocols include AMBA Advanced High-Performance Bus (AHB) [22] and Advanced eXtensible Interface (AXI) from ARM Holdings [23], Wishbone from Silicore Corporation [24], OCP from OCP-IP [25], CoreConnect from IBM [26], and STBus from STMicroelectronics [27]. These each define a large number of wires for several sets of bus signals and very complicated hardware structures, which are much more costly in terms of silicon area and energy consumption. Moreover, all of these buses transfer data linearly; however, in some specific applications such as AES cryptology, image processing, computer vision, and wireless communication, data processing is usually based on the relationship of data neighbors, adjacency, connectivity, regions, and boundaries. In these cases, data transfer by matrix or block, as provided in embodiments of the subject invention, is preferable to data transfer by linear burst. Thus, the related art bus architectures are unsuitable for resource-limited, energy-constrained, and security-focused (AES-encrypted) Internet-of-Things (IoT) devices.

As an improvement over the related art, an embodiment of the subject invention provides a compact and high-efficiency bus architecture (CDBUS) for AES-encrypted embedded systems to enhance IoT chip performance and capabilities to provide efficient architectural support for the AES cipher algorithm. The CDBUS architecture can include a high-performance data bus (DBUS), able to sustain the memory bandwidth, on which the application-specific devices, Direct Memory Access (DMA) with an AES encryption/decryption (ENC/DEC) core, and memory reside. DBUS provides a high-bandwidth interface between the elements that are involved in the majority of transfers. It creates two novel transfer modes—block and AES state transfers, and also backward supports the existing linear mode. In the linear mode, the data size signal gives the exact number of transactions in the row-major order. In addition, the block transfer is supported by DBUS to improve the performance of matrix-based applications in many fields, such as image processing, computer vision, and wireless communication. The block transfer defines the rectangle size and makes every memory boundary-crossing command computable by hardware, so that the time consumption of software configuration and bus commands is reduced.

In many embodiments, the innovative transfer mode, AES state transfer, is a major contribution to the specific AES-encrypted bus architecture. It is designed for the maximum pipeline and parallelism between data transfers and encryption/decryption processing, reducing state supplying load of the whole system. First, an AES state is adopted as the basic data unit of the state transfer; second, the state transfer processes data in the column-major order; and third, the plaintext state is cyclically shifted read into the ENC engine, and the ciphertext state is cyclically inverse-shifted written into the DEC engine. In addition, as the only slave of DBUS, the DMA connected with the AES ENC/DEC engine is optimized. DBUS can define the dynamic request-arbitration and command pre-processing schemes on the DMA structure. Moreover, using the specific AES state transfer mode and the composite field arithmetic, a full pipeline and maximum overlapping AES core can be provided.

The CDBUS designs of the subject invention cost less in terms of hardware resources than the related art industrial bus designs, and the CDBUS cipher tests achieve higher valid bandwidth (VDB) and consume less dynamic power (DP) than the related art bus tests. For the CDBUS architecture, a 128-bit design achieves higher VDB, but consumes more DP than 32- and 64-bit designs. In contrast, a 32-bit DMA consumes less power, but sacrifices bandwidth and area. Based on the resource and performance requirements, a user can choose a CDBUS implementation to fulfill the tradeoffs of a specific application.

Embodiments of the subject invention can result in reduced processor load, less memory space required, increased processing speed (e.g., less processing steps required), energy savings, miniaturization (e.g. less required space for GUI functionality), simplified software development, reduced hardware requirements, improved usability, enhanced reliability, and/or reduced error rate comparted to the related art. The growing number and complexity of IP blocks and subsystems in SoC designs challenge even the most experienced design teams, especially when the on-chip bus architecture is based on protocol that is new or otherwise unfamiliar to the team. The CDBUS structures of the subject invention are very desirable for IoT embedded systems with requirements of a reduced interface, high energy-efficiency, and/or AES algorithm speedup. Moreover, the single-processor and multi-client bus structure of CDBUS reduces resource utilization and energy consumption, and limits the complexity of circuits. Therefore, the CDBUS protocol is very desirable for, e.g., small-scale embedded systems with requirements of a low-cost interface and low-energy requirements.

It can often be challenging to integrate the industrial IP from multiple sources and/or vendors. The quality of the configuration and integration of complex IP blocks can have a significant impact on a SoC's development schedule and performance. In an embodiment of the subject invention, a CDBUS integration can mitigate or overcome this issue. CDBUS integration from different IP sources or vendors can use one or more configurable and reusable wrappers, along with a CDBUS design as presented herein. In theory, all industrial IPs can be seamlessly integrated in this way, although additional logic may affect system performance, in terms of slice/gate, latency, and power consumption. To meet the chip requirements, the system

Although an IoT device can be made up of many vertical segments, most applications that can make use of Internet-connected devices have a common foundation. For example, wearable and portable devices require basic functionality like being battery-limited, high-speed, and small-scale. In addition, network connectivity varies from application to application, but in general, the security needs are all common. Therefore, embodiments of the subject invention provide highly cost-effective, flexible, and easy-to-use on-chip architectures (CDBUS). Such architectures can be used to build an SoC that can interconnect seamlessly with industrial intellectual properties (IPs), delivering a broad-range of applications including micro-controller, on-chip memory, security encryption/decryption, wireless communication, and graphic processing.

CDBUS architecture is well-suited for smart IoT chips as it provides an excellent balance of cost and energy-efficiency. The universal and flexible structure, together with synthesizable DMA, AES engine, and several bus wrappers, provides the basics for an IoT endpoint chip design, which would allow fabless users to integrate application-specific modules, sensors, and other peripherals to create complete SoCs. Using CDBUS architecture, the design can be optimized with novel and high-efficiency transfer modes, including block and AES state transfers, and can enable chips with reduced size, cost, and power consumption.

Certain embodiments of the subject invention include an AES ENC/DEC engine supporting an AES state transfer mode on the data bus (DBUS) of the bus architecture. Certain implementations of the ENC/DEC engine may be based on composite field arithmetic.

As previously noted, the AES standard specifies the Rijndael algorithm, a symmetric block cipher that can process 128-bit states using cipher keys with lengths of 128, 192, and 256 bits. The key length is represented by Nₖ=4, 6, or 8, which denotes the number of 32-bit data blocks in the cipher key. For the AES algorithm, the number of rounds to be performed depends on the key size. It is represented by Nᵣ, where Nᵣ=10 when Nₖ=4, Nᵣ=12 when Nₖ=6, and Nᵣ=14 when Nₖ=8.

For both cipher and inverse-cipher processes, each AES round, except for the final round, consists of four different byte-oriented transformations: 1) non-linear byte substitution using a S-box (SB/ISB), 2) shifting rows of the state array (SR/ISR), 3) mixing the data within each column of the state array (MC/IMC), and 4) adding a round key to the state (AK). The final round does not have the MC/IMC transformation. Among the four transformations, SB/ISB is the bottleneck of the speed and power consumption of the AES core. The most common strategy to implement the S-box is employing the LUT-based design. However, a LUT-based design results in very high area overhead and forces the use of non-parallel structures due to the fixed operational delay of LUTs.

To overcome these limitations of LUTs, certain implementations use composite field arithmetic over GF(2⁸), which employs combinational logic only. In theory, the composite field of GF(2⁸) can be built iteratively from GF(2) using the irreducible polynomials [31]:

GF(2)→GF(2²):x²+x+1

GF(2²)→GF((2²)²):x²+x+Ø

GF(2²)²)→GF((2²)²)²):x²+x+λ (1)

First, x²+x+1 is the only irreducible polynomial of degree two over GF(2). Second, there are two values of Ø that make x²+x+Ø irreducible over GF(2²), and eight possible values of λ that make x²+x+λ irreducible over GF((2²)²) constructed by using each of Ø. All together, there are sixteen ways to construct the composite field GF((2²)²)²) using irreducible polynomials in Equation (1). In some implementations, Ø={10}₂, λ={1100}₂ is utilized.

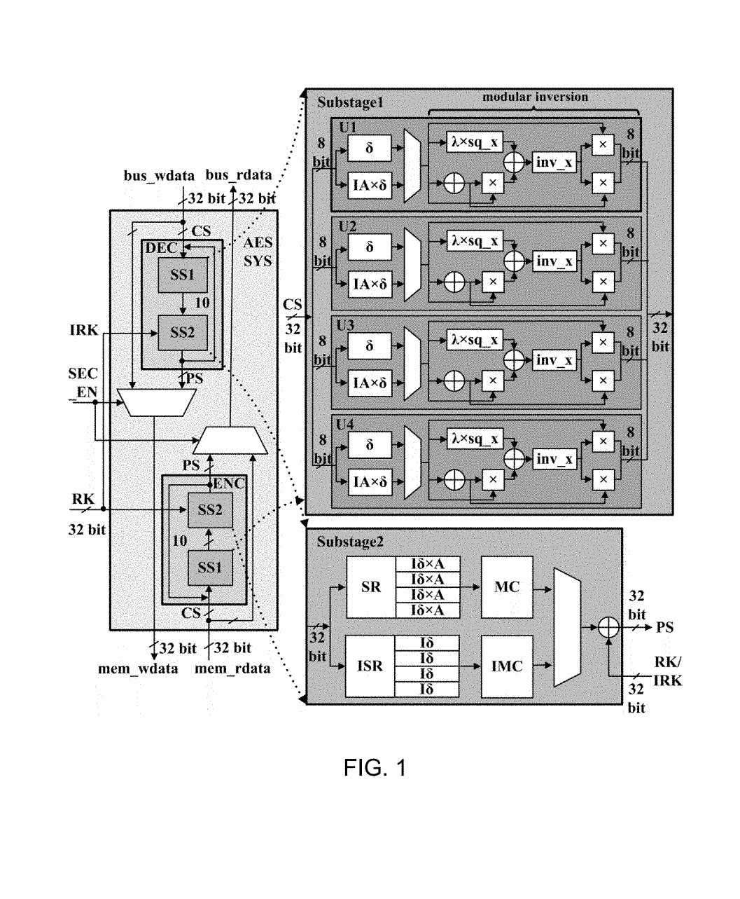

FIG. 1 shows a component diagram with an example 32-bit AES system structure including ENC and DEC engines. An AES system, or security core (SEC), as shown in FIG. 1 may be implemented, for example, as a core within a CDBUS DMA controller.

For the non-cipher mode, the AES ENC engine is bypassed on the read data path, and the AES DEC engine is bypassed on the write data path. Otherwise, e.g., in the cipher mode, the write data are decrypted before being stored into the memory, and the read data are encrypted before being transferred on the DBUS. Both ENC and DEC engines include two sub-stages (SS), SS1 and SS2, operating on an AES round. The SB/ISB transformation is decomposed as a modular inversion over GF(2⁴) located in SS1, and four linear functions (A, IA, δ, and Iδ). In order to shorten the SB/ISB critical path, IA is combined with δ (IA×δ) in SS1, and Iδ is merged with A (Iδ×A) in SS2. In addition, the SR/ISR, MC/IMC, and AK transformations are integrated into SS2 to obtain an approximately equal delay to SS1 for load balancing across the substages. In various implementations, the key expansion unit can be instantiated as either a hardware or a software generator. For example, to enhance the transfer efficiency of the system, the round keys are configured by software through the control bus in some cases.

The gate-level implementations of the AES operators may be described as follows. For simplicity, assume all the functions are black boxes with logic input and output. Let “a” denote the input and “b” denote the output in a one-in, one-out assignment. The bit-width of “a” and “b” are 8-, 4-, and 2-bit, respectively, when the operator is in GF(2⁸), GF(2⁴), and GF(2²) fields. Hence, the logic designs of δ and Iδ are written below:

b={a₇̂a₅,a₇̂a₆̂a₄̂a₃̂a₂̂a₁,a₇̂a₅̂a₃̂a₂,a₇a₅̂a₃̂a₂̂a₁,a₇̂a₆̂a₂̂a₁,a₇̂a₄̂a₃̂a₂̂a₁,a₆̂a₄̂a₁,a₆̂a₁̂a₀} (2)

b={a₇̂a₆̂a₅̂a₁,a₆̂a₂,a₆̂a₅̂a₁,a₆̂a₅̂a₄̂a₂̂a₁,a₅̂a₄̂a₃̂a₂̂a₁,a₇̂a₄̂a₃̂a₂̂a₁,a₅̂a₄,a₆̂a₅̂a₄̂a₂̂a₀} (3)

In the notation above, the concatenation operator “{,}” combines the bits of two or more data objects. In eq. (2) and eq. (3), 0 and Iδ are implemented by “XOR” gates denoted as “̂” hereafter. Likewise, the logic designs of A and IA can be represented as

b={a₇̂a₆̂a₅̂a₄̂a₃,˜a₆̂a₅̂a₄̂a₃̂a₂,˜a₅̂a₄̂a₃̂a₂̂a₁a₄̂a₃̂a₂̂a₁̂a₀,a₇̂a₃̂a₂̂a₁̂a₀,a₇̂a₆̂a₂̂a₁̂a₀,˜a₇̂a₆̂a₅̂a₁̂a₀,˜a₇̂a₆̂a₅̂a₄̂a₀} (4)

b={a₆̂a₄̂a₁,a₅̂a₃̂a₀,a₇̂a₄̂a₂,a₆̂a₃̂a₁,a₅̂a₂̂a₀,˜a₇̂a₄̂a₁,a₆̂a₃̂a₀,˜a₇̂a₅̂a₂} (5),

respectively. In these two equations, the “˜” operator indicates a bit-wise logic inversion of each input bit (see, e.g., [32]).

The multiplicative inversion module can be shared in a combined structure. Theoretically, any arbitrary polynomial can be represented as px+q where p is the upper half term and q is the lower half term. Denoting the irreducible polynomial as x²+Ax+B, the multiplicative inversion for an arbitrary polynomial px+q is given by

(px+q)⁻¹=p(p²B+pqA+q²)⁻¹x+(q+pA)(p²B+pqA+q²)⁻¹ (6)

Therefore, the inversion calculation in GF(2⁸) is transformed to the inversion in GF(2⁴) by performing some multiplications, squaring, and additions in GF(2⁴). The multiplication with constant λ and squaring in GF(2⁴) (e.g., shown in FIG. 1) can be combined together to reduce the combinational logic cost and shorten the critical path, which is modified as below:

b₃=a₂̂a₁̂a₀

b₂=a₃̂a₀

b₁=a₃

b₀=a₃̂a₂ (7)

Using the combining logic in Equation (7), the implementation of multiplication with constant λ and squaring in GF(2⁴) can be optimized as 4 “XOR” gates, with 2 “XOR” gates being in the critical path. It reduces the critical path by one “XOR” gate delay in comparison to [9].

Moreover, the multiplication in GF(2⁴) can be further decomposed into multiplication in GF(2²), and then to GF(2). For a two-in, one-out assignment, let “a” and “b” denote two inputs, and “c” denote the output hereafter. The bit-width of “a”, “b”, and “c” are 4-bit and 2-bit if the operator is in GF(2⁴) and GF(2²), respectively. Assume c=a×b, where a=a_{H}x+a_{L} and b=b_{H}x+b_{L}. Here, a_{H} and b_{H} are the upper half term, and a_{L} and b_{L} are the lower half term. Then, the product of a and b is

C=(b_{H}a_{H}+b_{H}a_{L}+b_{L}a_{H})x+b_{H}a_{H}φ+b_{L}a_{L} (8)

This equation is in the form of GF(2²). In order to decompose the GF(2²) multiplication to GF(2), the logic for computing the GF(2) multiplication is rewritten as

c₁=b₁a₁̂b₀a₁̂b₁a₀

c₀=b₁a₁̂b₀a₀ (9)

and the logic for computing GF(2) multiplication with constant φ is

b₁=a₁̂a₀

b₀=a₁ (10)

Thus, using Equations (9) and (10), the multiplication in GF(2⁴) can advantageously be implemented in hardware as multiplication involving only “XOR” and “AND” gates.

In theory, the inversion in GF(2⁴) can be implemented by repeated squaring and multiplication, decomposing inversion by applying formulas similar to Equation (6) iteratively, and computing each inverse bit individually [31]. Using the direct implementation of the inverse bit, the GF(2⁴) inversion is shown as below:

b₃⁻¹=a₃̂a₃a₂a₁̂a₃a₀̂a₂

b₂⁻¹=a₃a₂a₁̂a₃a₂a₀̂a₃a₀̂a₂̂a₂a₁

b₁⁻¹=a₃̂a₃a₁a₀̂a₂̂a₂a₀̂a₁

b₀⁻¹=a₃a₂a₁̂a₃a₂a₀̂a₃a₁̂a₃a₁a₀̂a₃a₀̂a₂̂a₂a₁̂a₂a₁a₀̂a₁̂a₀ (11)

This completes the SB/ISB composite field logic implementation. For the SR/ISR transformation, the bytes in the last three rows of the state are cyclically shifted/inverse shifted over different numbers of bytes. The first row is not shifted. The second, third, and fourth rows are left-shifted one, two, and three bytes for the SR transformation, and right-shifted one, two, and three bytes for the ISR transformation, respectively. Since the cyclic rotation does not affect the regrouping result, the order of Iδ×A/Iδ and SR/ISR is further exchanged, as shown in FIG. 1. In this way, the four byte-size outputs of SS1 can be reordered per the shifted/inverse-shifted rules and merged with Iδ×A/Iδ operators, then combined with the word-size input of the MC/IMC transformation in SS2. In some cases, an XTime method, composed of a fundamental multiplication block called XTime that multiplies a byte with constant values {02} and {04}, is used. Ifs denotes the initial bytes of a state, the logic designs of {02}s and {04}s are

b={a₆,a₅,a₄,a₃̂a₇,a₂̂a₇,a₁,a₀̂a₇,a₇} (12)

b={a₅,a₄,a₃̂a₇,a₂̂a₆̂a₇,a₁̂a₆,a₀̂a₇,a₆̂a₇,a₆} (13),

respectively. Let the prefix “s_” denote the MC output signal and “is_” denote the IMC output signal. The logic implementations of MC and IMC can be written as:

s_s₀={02}(s₀̂s₁)̂s₂̂s₃̂s₁

s_s₁={02}(s₁̂s₂)̂s₃̂s₀̂s₂

s_s₂={02}(s₂̂s₃)̂s₀̂s₁̂s₃

s_s₃={02}(s₃̂s₀)̂s₁̂s₂̂s₀ (14)

is_s₀=({02}(S₀̂s₁)̂s₂̂s₃̂s₁)̂({02}({04}(s₀̂s₂)+{04}(s₁̂s₃))+{04}(s₀̂s₂))

is_s₁=({02}(s₁̂s₂)̂s₃̂s₀̂s₂)̂({02}({04}(s₀̂s₂)+{04}(s₁̂s₃))+{04}(s₁̂s₃))

is_s₂=({02}(s₂̂s₃)̂s₀̂s₁̂s₃)̂({02}({04}(s₀̂s₂)+{04}(s₁̂s₃))+{04}(s₀̂s₂))

is_s₃=({02}(s₃̂s₀)̂s₁̂s₂̂s₀)̂({02}({04}(s₀̂s₂)+{04}(s₁̂s₃))+{04}(s₁̂s₃)) (15)

In Equation (14) and Equation (15), s₀, s₁, s₂, and s₃ represent the first, second, third, and fourth bytes in a column of a state, respectively. In the final AK transformation, a round key is added to the state by a simple bitwise XOR operation. For the ENC engine, the 10-round keys from RK(0) to RK(a) are input in the forward direction, and the direction is reversed from RK(a) to RK(0) in the DEC engine round key application.

From these gate-level implementations, the gate costs and critical path for each operator can be determined and are summarized in Table I. In some embodiments, the internal pipeline structure of the AES system described in FIG. 1 can achieve an optimized speed if each round unit can be distributed among the substages SS1 and SS2 to achieve an approximately equal delay. For instance, the cipher/inverse-cipher core can be divided into two substages SS1 and SS2 with approximately equal critical path latencies. With respect to the ENC engine, the critical path of SS1 has 15 XOR gates and 1 MUX, and the critical path of SS2 has 8 XOR gates and 1 MUX. With respect to the DEC engine, the critical path of SS1 has 16 XOR gates and 1 MUX, and the critical path of SS2 has 11 XOR gates and 1 MUX. In the example shown in FIG. 1, four 8-bit interface units (U1, U2, U3, and U4) are instanced in SS1 to interconnect with the 32-bit SS2. In SS2, the 8-bit operator, Iδ×A, is duplicated four times to match the 32-bit SR/ISR and MC/IMC transformations.

TABLE I
AES ENC/DEC Gate Costs and Critical Path

| Modules | Total Gates | Critical Path |
|---|---|---|
| δ | 12XOR | 4XOR |
| x² × λ | 4XOR | 2XOR |
| Multiplier in GF(2⁴) | 21XOR + 9AND | 4XOR + 1AND |
| x⁻¹ | 14XOR + 9AND | 3XOR + 2AND |
| δ⁻¹ × A | 19XOR | 4XOR |
| A⁻¹ × δ | 19XOR | 3XOR |
| δ⁻¹ | 17XOR | 3XOR |
| MC | 108XOR | 3XOR |
| IMC | 193XOR | 7XOR |

In certain embodiments, a CDBUS architecture can include an AES-based bus architecture.

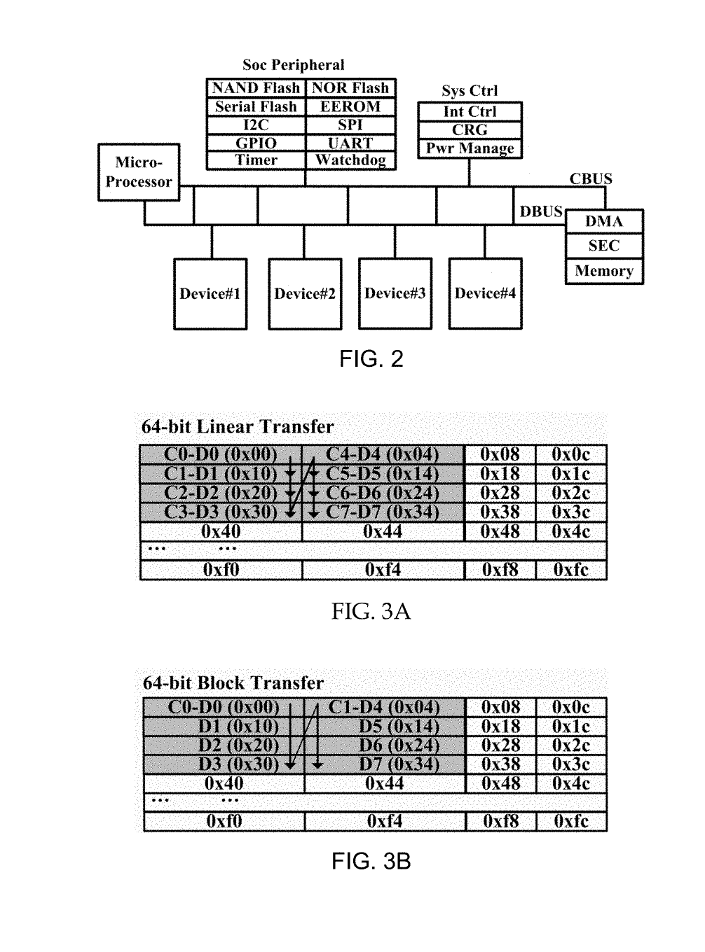

FIG. 2 shows an example of components arranged in an AES-based bus (CDBUS) architecture. The CDBUS consists of a high-performance data bus (DBUS), able to sustain the memory bandwidth, on which the micro-processor, application-specific devices, and DMA with a security core (e.g., the AES system with ENC/DEC engine) and memory reside. The DBUS provides a high-bandwidth interface between the elements that are involved in the majority of transfers. The role of the DMA in this architecture is to control which master devices has access to DBUS and to arbitrate the data transfers between the masters and memory. Also located on the architecture is a control bus (CBUS), which may have a lower bandwidth. The CBUS connects functional register configuration modules, such as SoC peripherals, system control modules, and application-specific devices.

An important role of DBUS is high-throughput data transfers. In some cases, DBUS is a full-duplex bus supporting multiple master devices and a single slave device, the DMA controller. In varying embodiments, the DBUS provides a specific AES state-based transfer mode, supports a block transfer mode, and supports the traditional linear transfer modes.

Table II shows an example of data bus signals (prefixed with “d_”) that may support a 32-bit implementation of DBUS. For instance, every DBUS master has a pair of “d_req_x” and “d_gnt_x” interfaces to the DMA arbiter to ensure that only one master has access to the bus at any one time. The DMA arbiter may perform this function by observing a number of different requests to use the bus and deciding which master currently requesting the bus is the highest priority. The write data channel includes “d_wdata” and “d_wdata_vld” signals. Each bit of the “d_wdata_vld” signal indicates that the related-byte of the write data is signaling valid. The bit width of the “d_wdata_vld” signal is 1, 2, 4, 8, 16, respectively, for the byte, half-word, word, double-word, quad-word write data channel. The “d_resp[1:0]” signal indicates that the slave is ready to accept the command and associated data, “d_resp[1]” for write and “d_resp[0]” for read.

TABLE II
32-Bit DBUS Signals

| Name | Source | Description |
|---|---|---|
| d_req_x | DBUS | When high it indicates that the master |
| | Masters | requests DBUS occupation. |
| d_gnt_x | DMA | When high it indicates that the request |
| | | has been granted by DMA. |
| d_addr[31:0] | DBUS | The 32-bit address of DBUS. |
| | Masters | |
| d_wr | DBUS | When high it indicates a write transfer |
| | Masters | and when low a read transfer. |
| d_len[11:0] | DBUS | The d_len[11:10] signal determines the |
| | Masters | transfer modes, and the d_len[9:0] |
| | | signal gives the transfer size. |
| d_wdata[31:0] | DBUS | It is used to transfer data from masters |
| | Masters | to DMA during write operations. |
| d_wdata_vld[3:0] | DBUS | When high each bit indicates the related |
| | Masters | valid byte of the write data. |
| d_rdata[31:0] | DMA | It is used to transfer data from DMA to |
| | | masters during read operations. |
| d_resp[1:0] | DMA | When high the d_resp[1]/d_resp[0] |
| | | signal indicates that a write/read data |
| | | transaction has finished. It may be driven |
| | | low to extend a transfer. |

In addition to the transfer mode, each transfer has a number of command signals that provide additional information about the transfer. The “d_addr” signal gives the address of the first data in a transfer, and the “d_wr” signal indicates the transfer direction, logic one for write and logic zero for read.

In embodiments of the DBUS supporting three transfer modes (e.g., linear, block, and AES state), the two most significant bits of the data size signal “d_len” can be used to indicate the transfer mode. For example, the transfer mode is indicated as the linear mode when the “d_len[11:10]” signal is binary logic “2′b00”, the block mode when logic “2′b01”, and the state mode when logic “2′b10”.

In some embodiments, the DBUS supports the transfer of data bytes over three transfer modes by using “d_len” signal. For example, in the linear transfer mode, the signal “d_len[9:0]” gives the exact number of transactions in the row-major order. However, the number of transactions in a linear transfer is not the number of data bytes. The total amount of data bytes in a linear transfer is calculated by multiplying the number of transactions by the bus width (in bytes). If DS denotes the bus size parameter, the DS values of 0, 1, 2, 3, and 4 represent the bus width as byte, half word, word, double word, and quad word, respectively. Then, the total number of data bytes in a linear transfer mode is:

NDB_{L}=d_len[9:0]<<DS (16)

(Here, the shift operators “<<” (and “>>”) perform left (and right) shifts of their left operand by the number of bit positions given by the right operand.)

Continuing the example, for a block transfer the “d_len[5:0]” signal represents the block height, and the “d_len[9:6]” signal represents the block width in the row-major order. Therefore, the total number of data bytes in a block mode is:

NDB_{B}=(d_len[9:6]<<DS)×d_len[5:0] (17)

For the AES state transfer mode, the “d_len[9:0]” signal indicates the number of AES states. Thus, the total number of data bytes is:

NDB_{S}=(d_len[9:0]<<4) (18)

The transfer mode also determines how the address for each transaction within a transfer is calculated. The initial address denoted by “ADDR_0” of all the three transfer modes is:

ADDR_0=(SADDR<<DS)>>DS (19)

Then, the Mth transaction address in a linear transfer is:

ADDR_{L—}M=ADDR_0+(M<<DS) (20)

Now, let MWD denote the address gap between the data of the vertical neighbors. In the block transfer mode, the address of the Mth transaction in the Nth line of a block is:

ADDR_{B—}M_N=ADDR_0+(N×MWD)+(M<<DS) (21)

Lastly, since the state transfer mode processes data by the 128-bit state, the address of the Mth state in the Nth state-line of a transfer is

ADDR_{S—}M_N=ADDR_0+[(N×MWD)<<2]+(M<<2) (22)

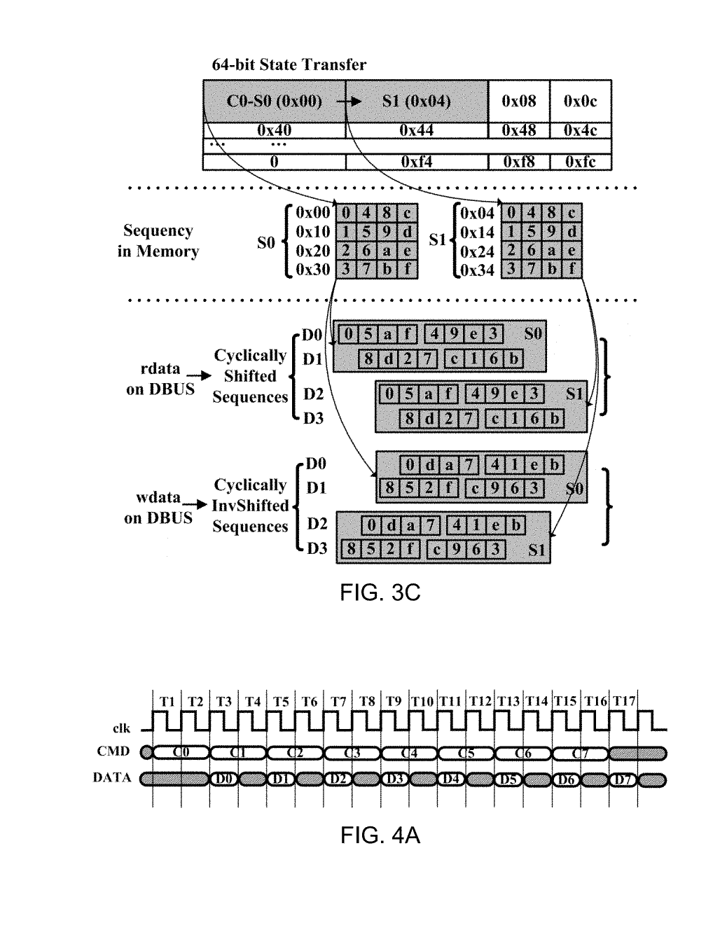

FIGS. 3A-3C show examples of memory access for the DBUS transfer modes. These examples illustrate and contrast the memory access behaviors of the DBUS transfer modes supported in varying embodiments.

FIG. 3A shows an example of operation of the legacy linear transfer mode supported in some embodiments. In FIG. 3A, eight consecutive linear transfers are used to access two 4×4-byte matrices. Each transfer includes one command stage (prefaced with “C”) and one data stage (prefaced with “D”).

FIG. 3B shows an example of operation of the block transfer mode present in some embodiments. A block transfer mode is provided by DBUS, for example, to improve the performance of matrix-based applications in some specific fields, such as image processing, computer vision, and wireless communication. A block transfer mode defines the memory “rectangle” size and can make every memory boundary-crossing command computable by hardware, so the overall quantity of software configuration and bus commands is reduced, reducing processing time. Since the consecutive data of the rows of the array, matrix, or block are contiguous in memory, the block transfer is essentially a row-major order transfer. However, the number of command stages is reduced over the linear transfer mode. FIG. 3B shows a memory access example with two 4×4-byte matrices using the block mode. Two block transfers are used to load or store two matrices, and each of the transfers involves one command stage (prefaced with “C”) and four data stages (prefaced with “D”).

FIG. 3C shows an example of operation of the AES state transfer mode present in certain embodiments of the subject invention. The AES state transfer mode may advantageously optimize data supply efficiency involving encryption/decryption processing. This transfer mode may reduce the processing load of data scheduling and buffering and power consumption in system environments making use of AES cryptographic processing.

In implementations with the AES state transfer mode, the “AES state” is adopted as the basic unit of data transfer on the DBUS. The AES state transfer is processed on the DBUS in the column-major order, rather than the row-major order of linear and block modes. In a “read” operation, the plaintext state is cyclically-shifted into the ENC engine, and on a “write” operation the ciphertext state is cyclically-inverse-shifted into the DEC engine. FIG. 3C shows the memory layout, where only one command (C0) is required to transfer two AES states (S0 and S1). Each state is processed in column major order (i.e., column-by-column) and cyclically-shifted/cyclically-inverse-shifted.

For example, assume the byte sequence in an AES state is from hexadecimal “0” to “3”, “4” to “7”, “8” to “b”, “c” to “f” for the first, second, third, and fourth columns, respectively, as shown in memory sequence. The first write data sequence shown on the 64-bit DBUS is hexadecimal “0”, “5”, “a”, “f”, “4”, “9”, “e”, “3”, and the second write data sequence is hexadecimal “8”, “d”, “2”, “7”, “c”, “1”, “6”, “b”, which are cyclically inverse shifted before entering the DEC engine. Likewise, the first read data sequence is hexadecimal “0”, “d”, “a”, “7”, “4”, “1”, “e”, “b”, and the second read data sequence is hexadecimal “8”, “5”, “2”, “f”, “c”, “9”, “6”, “3”, which are cyclically shifted before enter the ENC engine.

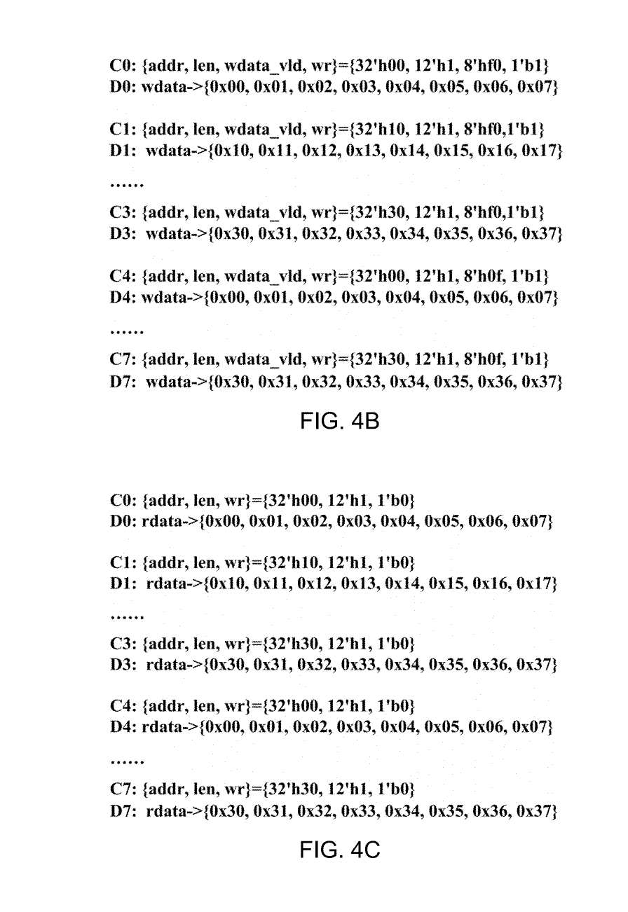

FIGS. 4A-6C contain timing diagram and write/read processing examples to illustrate and contrast the behaviors of the DBUS transfer modes supported in varying embodiments.

FIG. 4A shows a timing diagram example of a 64-bit linear transfer mode supported in some embodiments. In this traditional data transfer mode, commands are used for each non-linear boundary-crossing operation of memory. Thus, eight transfers, including command (C0 to C7) and data stages (D0 to D7), are necessary to access two 4×4-byte matrices. The DBUS provides the command preprocessing scheme and full-duplex bus operations, therefore, as shown in the figure, the command stages are consecutive and parallel with the data phases. FIGS. 4B and 4C show detailed information of the linear write and linear read processing, respectively. In this and later figures, the “->” operator denotes the associated memory address of the data in the bracketed byte. Since the bus width is 64-bit in the example in FIG. 4B, only the data bits from 63 to 32 are valid for the first to the fourth transfers (C0-D0 to C3-D3), and only the data bits from 31 to 0 are valid for the fifth to the seventh transfers (C4-D4 to C7-D7), which are indicated by the “d_wdata_vld” signal as “8′hf0” and “8′h0f”, respectively. FIG. 4C is arranged similarly to FIG. 4B for read data.

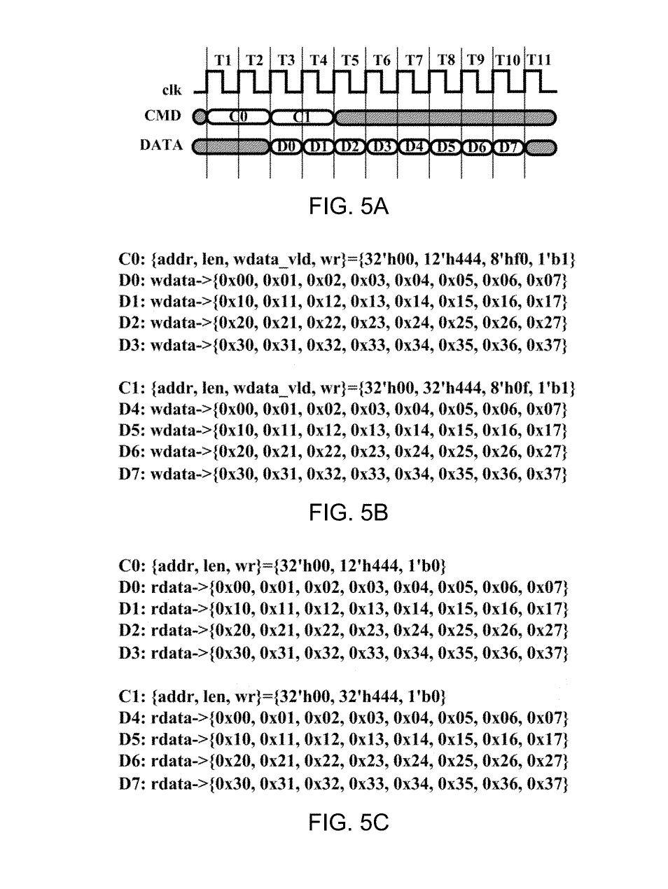

FIG. 5A shows a timing diagram example of a 64-bit block transfer mode in some embodiments. The block transfer mode defines all the block boundary-crossing addresses and the transfer size with the initial command. Thus, only two command stages (C0 and C1) are required to access two 4×4-byte matrices. As the timing diagram example of FIG. 5A shows, the command stage of the second transfer (C1) is overlapped with the first and the second data stages (D0 and D1). FIGS. 5B and 5C show detailed information about commands and data of the block write and read processing, respectively. The 4×4-byte block size is represented by the signals “d_len[9:6]” and “d_len[5:0]” as the column number (hexadecimal 4′h1) and the row number (hexadecimal “6′h4”). Similarly to the linear write transfer example, FIG. 5B shows that only the write data bits from 63 to 32 are valid for the first matrix transfer (C0-D0 to D3), and only the write data bit from 31 to 0 are valid for the second matrix transfer (C1-D4 to D7), which are indicated by the “d_wdata_vld” signal as “8′hf0” and “8′h0f”, respectively. FIG. 5C is arranged similarly to FIG. 5B for read data.

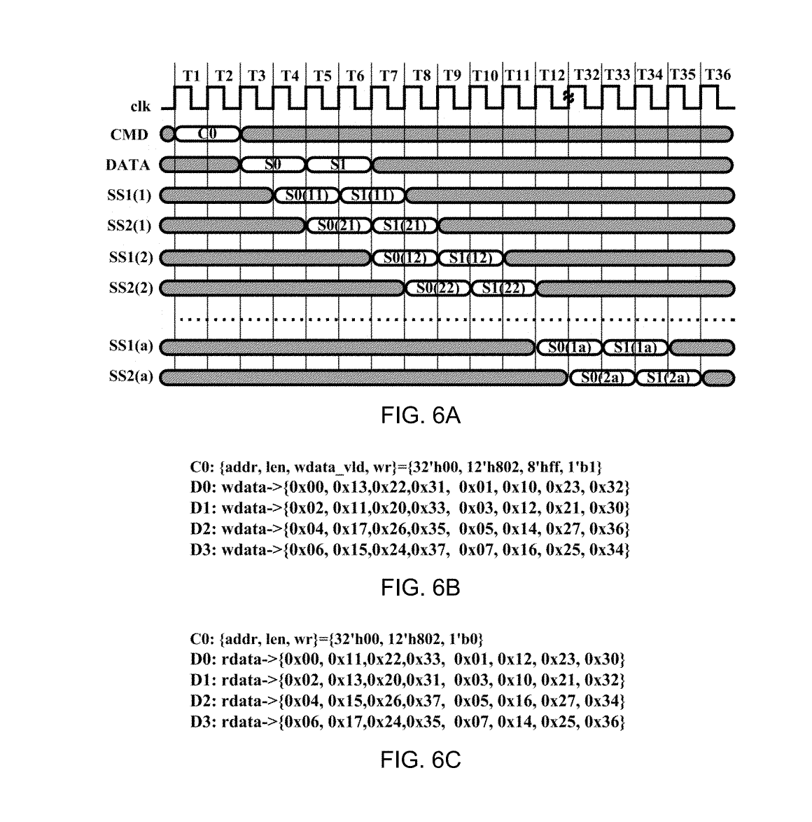

FIG. 6A shows a timing diagram example of an AES state transfer mode present in certain embodiments. The timing diagram example shows that only one command stage (C0) is required for the two-state (S0 and 51) transfer. In addition, encryption/decryption processing begins immediately at the T4 cycle because the first double word of the T3 cycle is cyclically shifted/inverse shifted already.

Each processing of an AES state involves multiple rounds (e.g., ten rounds), and each round of encryption/decryption involves two substages in embodiments having a AES ENC/DEC engine—SS1(n) and SS2(n) (where “n” denotes the round number ranging from hexadecimal “1” to “a”). For the write data process, the ciphertext states use ten-round decryption (SS1(1)-SS2(1) through SS1(a)-SS2(a)) before being written into memory. Likewise, for the read data process, the plaintext states use ten-round encryption (SS1(1)-SS2(1) through SS1(a)-SS2(a)) before being transferred on the bus. In FIG. 6A, S0(mn) and S1(mn) denote the first and the second states in the mth SS (substage) of the nth round, respectively. Therefore, “m” ranges from hexadecimal “1” to “2”, which represents the first and the second SS, and “n” ranges from hexadecimal “1” to “a”, which represents the first to the tenth round.

The state processing for ten rounds of the same AES state are internal pipeline (from S0(m1) to S0(ma), or from S1(m1) to S1(ma)) and parallel (S0(1n) and S0(2n), or S1(1n) and S1(2n)), and the state processing among different AES states are external pipeline (from S0(mn) to S1(mn)). Consequently, for the 64-bit bus, the shifted plaintext states read from memory are continuous and the ciphertexts shown on the bus can be consecutive after 30-cycle encryption. Furthermore, and the inverse-shifted ciphertext states shown on bus are consecutive and the plaintexts written into memory can be continuous after 30-cycle decryption.

FIG. 6B and FIG. 6C show detailed commands and data of the state transfer write and read operations, respectively. First, all the write data driven on DBUS is valid due to the specific state-unit operation of the state mode, which is indicated by the “d_wdata_vld” signal as hexadecimal “8′hff”. Second, the read/write data is cyclically shifted/inverse shifted before entering the ENC/DEC engine. As shown in FIG. 6B, the byte-unit memory addresses of the first word data, which are driven on the upper half term of the first double-word, are hexadecimal 0x00, 0x11, 0x22, and 0x33. They are cyclically shifted as the first column of the state input to the ENC engine.

Aspects and advantages of the DBUS architecture in certain embodiments may be understood in comparison to existing bus architectures, e.g., AXI. For example, bus transfer efficiency and bandwidth metrics contrasting DBUS and AXI can be considered.

Initially, to estimate the DBUS transfer efficiency, performance metrics of both AXI and DBUS are formulated and compared. CY denotes the total number of clock cycles of a specific data transfer. To consider the bus efficiency, it can be assumed that any bus request is always granted immediately.

Let P_{XL} and P_{DL}, respectively, denote the probability of AXI back-to-back transfers and the probability of DBUS back-to-back transfers in the linear mode. Moreover, let N_{L} denote the number of data bursts in the linear mode. Since the command and data phases can be overlapped between two consecutive transfers, the AXI linear transfer (XL) latency, denoted by CY_{XL}, can be formulated as

CY_{XL}=4ceil(N_{L}/XS)+N_{L}−2ceil(N_{L}/XS)×P_{XL}. (23)

where P_{XL} ranges from 0 to [ceil (N_{L}/XS)−1]/ceil(N_{L}/XS). In this equation, the ceil( ) function represents that rounds fraction up. XS indicates the maximum AXI burst size, specified by ARLEN for read and AWLEN for write. It is 16 for AXI3 and 256 for AXI4 compatibility. In this equation, each AXI transfer requires four command cycles, two requests, one address, and one response, when the response to any bus transfer is always available immediately and all the command transactions are back-to-back.

In contrast, DBUS integrates the arbitration and address phases together, and also combines the data and slave-driven response phases. Therefore, it uses only two cycles with an immediate grant. The total latency of DBUS linear (DL) transfers, denoted by CY_{DL}, can be represented as

CY_{DL}=2ceil(N_{L}/DS)+N_{L}−2ceil(N_{L}/DS)×P_{DL}. (24)

where DS represents the maximum DBUS transfer size, which is 1024 bursts for the 10-bit DBUS length signal. In this equation, P_{DL} ranges from 0 to [ceil (N_{L}/DS)−1]/ceil(N_{L}/DS).

AXI protocol does not define how to access data by block. Hence, designers must consider the specific operations for the matrix-based applications and algorithms, and analyze the trade-off between hardware cost and speed. Let N_{H} and N_{W}, respectively, denote the block height and block width. Using the AXI linear transfer type, the total cycles of a block processing (XB) can be calculated as

CY_{XB}=4N_{H}×ceil(N_{W}/XS)+N_{H}×N_{W}−2N_{H}×ceil(N_{W}/XS)×P_{XB}. (25)

Here, P_{XB} represents the probability of the back-to-back AXI block transfers, which ranges from 0 to [N_{H}×ceil (N_{W}/XS)−1]/[N_{H}×ceil (N_{W}/XS)].

Due to the built-in boundary-crossing scheme of the block transfer, each matrix operation consumes only one command stage for DBUS. The total cycle cost of a DBUS block transfer (DB) can be formulated as

CY_{DB}=2ceil(N_{H}/DH)×ceil(N_{W}/DW)+N_{H}×N_{W}−2ceil(N_{H}/DH)×ceil(N_{W}/DW)×P_{DB}. (26)

where DH and DW are the maximum block height and the maximum block width that can be processed by the DBUS block transfer. As an example, DH is 32 for a 5-bit block height signal, and DW is 16 for a 4-bit block width signal. P_{DB} denotes the probability of the back-to-back DBUS block transfers, which ranges from 0 to [ceil (N_{H}/DH)×ceil (N_{W}/DW)−1]/[ceil (N_{H}/DH)×ceil (N_{W}/DW)].

The AES cipher/inverse-cipher tests consume not only the command and data cycles on bus, but also the AES encryption/decryption latency. Assume that the encryption/decryption processing is full pipeline, each cipher/inverse-cipher round uses 5 clock cycles for the 32-bit bus, in which 4 cycles are consumed by SS1 and 4 cycles are consumed by SS2 with 3 cycles overlapped. Likewise, 3 cycles are needed for the 64-bit bus and 2 cycles are needed for the 128-bit bus to complete each AES state round. Furthermore, assume that all the transfers are back-to-back, and the command stages, data stages, and AES cipher/inverse-cipher operations are completely overlapped. The total number of cycles spent by the 32-, 64-, and 128-bit AXI cipher/inverse cipher (XC) tests to process N_{C} AES states can be calculated as:

CY_{XC32}=2+6N_{C}+50N_{C}−((12N_{C}+38N_{C})×P_{XC}) (27)

CY_{XC64}=2+4N_{C}+30N_{C}−((6N_{C}+24N_{C})×P_{XC}) (28)

CY_{XC128}=2+3N_{C}+20N_{C}−((3N_{C}+17N_{C})×P_{XC}) (29)

Notice that the back-to-back probability of AXI cipher test ranges from 0 to (N_{C}−1)/N_{C}.

For the specific state transfer mode of DBUS, only one command is required for a write or read operation with less than or equal to 1024 states, due to the 10-bit width definition of the “d_len[9:0]” signal. The number of processing cycles depends on the DBUS size. For instance, 4N_{C}, 2N_{C}, and N_{C} cycles are needed to transfer N_{C} states for the 32-, 64-, and 128-bit DBUS, respectively. Therefore, the total cycles consumed by DBUS cipher/inverse cipher (DC) tests are

CY_{DC32}=2+4N_{C}+50N_{C}−((4N_{C}+46N_{C})×P_{DC}) (30)

CY_{DC64}=2+2N_{C}+30N_{C}−((2N_{C}+28N_{C})×P_{DC}) (31)

CY_{DC128}=2+N_{C}+20N_{C}−((N_{C}+19N_{C})×P_{DC}) (32)

for the 32-, 64-, and 128-bit DBUS, respectively.

Table III summarizes the above analysis.

TABLE III
Modeling Performance Comparison

| Tests | CY |
|---|---|
| XL | (4 − 2P)ceil(N_{L}/XS) + N_{L} |
| DL | (2 − 2P)ceil(N_{L}/DS) + N_{L} |
| XB | (4 − 2P) × N_{H} × ceil(N_{W}/XS) + N_{H} × N_{W} |
| DB | (2 − 2P) × ceil(N_{H}/DH) × ceil(N_{W}/DW) + N_{H} × N_{W} |
| 32-bit XC | 2 + 2N_{C}(28 − 25P) |
| 64-bit XC | 2 + 2N_{C}(17 − 15P) |
| 128-bit XC | 2 + 2N_{C}(23 − 20P) |
| 32-bit DC | 2 + 2N_{C}(27 − 25P) |
| 64-bit DC | 2 + 2N_{C}(16 − 15P) |
| 128-bit DC | 2 + 2N_{C}(21 − 20P) |

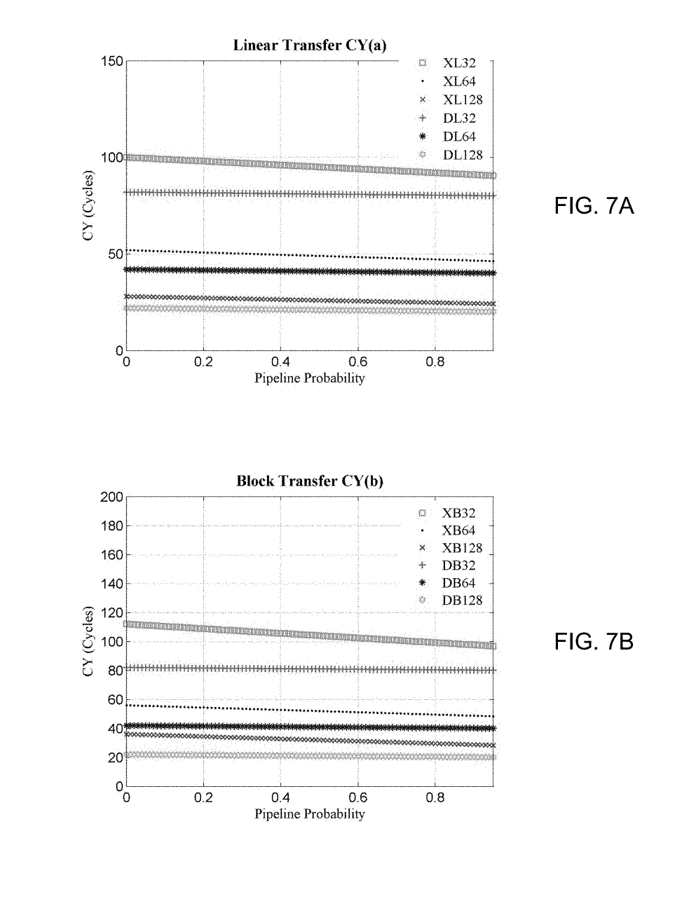

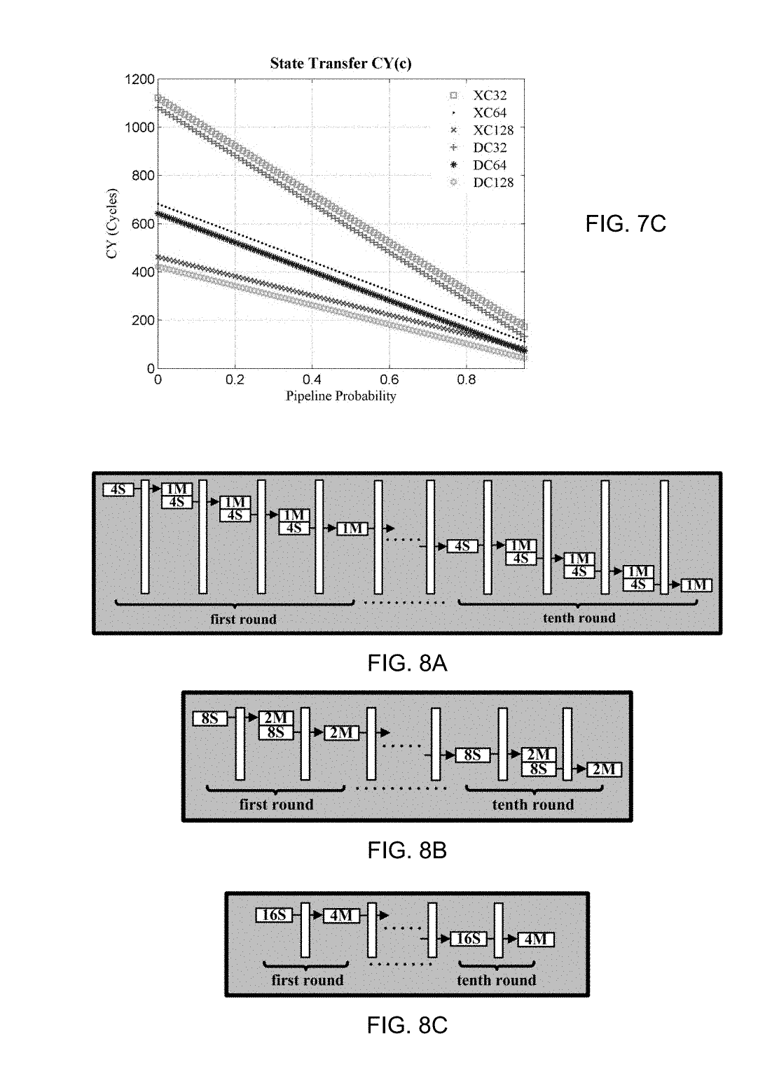

A comparison of AXI and DBUS CY over different bus sizes is illustrated in FIGS. 7A-7C. For example, assume that the total state number (N) is 10, which is the smallest state number for a ten-round parallel processing of encryption/decryption operations. The horizontal axis represents the back-to-back pipeline probability (P) from 0 to 0.95. As the latency of linear test cases, involving XL and DL shown in FIG. 7A, the clock cycles consumed by the DL transfers are 88.51%, 86.61%, and 83.06%, respectively, for all the 32-, 64-, and 128-bit bus sizes, compared with the XL tests when P reaches the maximum (0.95).

Likewise, the clock cycles consumed by the DB transfers are 82.75%, 82.85%, and 70.77%, respectively, compared with the XB tests for all the three bus sizes' tests, as shown in FIG. 7b.

The comparison between AXI and DBUS cipher tests are further shown in FIG. 7C. For the same bus size, the DC test consumes less cycles than the XC test. As an example, when P is the maximum 0.95, the clock cycles consumed by DBUS transfers are 76.74%, 64.29%, and 51.22% compared with AXI transfers for 32-, 64-, and 128-buses, respectively.

In order to realize an optimized structure for the ENC/DEC engine described in some embodiments, some configurations may be selected to account for high logic overhead and optimize the number of parallel resources. FIGS. 8A-8C show the pipeline structures and the resource costs depending on bus-widths in different implementations. Let S and M denote the logic utilization of SS1 and SS2, respectively. When the bus size is 32-bit, as shown in FIG. 8A, four parallel S (4S) instances connected with one M (1M) instance are necessary to internally pipeline and parallel the ten-round cipher/inverse-cipher processing per state. Furthermore, in order to externally pipeline all the ten rounds among different states, hardware resources are duplicated ten times. Additionally, the hardware resources are doubled to externally parallel the write and read channels of the full-duplex bus.

In a 64-bit bus-based implementation, shown in FIG. 8B, the cipher/inverse-cipher processing can be sped up, but the number of S and M instances is doubled. This implementation requires eight S (8S) and two M (2M) instances for the encryption/decryption process of each round in order to parallelize and internally pipeline the data transfer. Sixteen S (16S) and four M (4M) are used in the 128-bit bus-based implementation shown of FIG. 8C. Like the 32-bit implementation, both the 64-bit and 128-bit bus-based designs require ten-time duplication, and then double the S and M instances, to externally pipeline the different states and parallelize the write & read channels.

In some embodiments, as an alternative technology to an ASIC design, a field-programmable gate array (FPGA) implements the basic combinational logic via 2^{k}-bit static random-access memory (SRAM) representing a k-input and one-output LUT. Such an implementation is capable of realizing any Boolean function of up to k variables by loading the SRAM cell with the truth table of that function. In a 128-bit bus design, for example, an FPGA implementation may have a reduced FPGA slice usage due to the short path of each cipher/inverse-cipher round, despite the higher number of S and M instances.

Certain embodiments of the bus architecture include a control bus (CBUS) having various aspects. Advantageously, the CBUS can provide low-speed and/or low-bandwidth functional register operations with a low-cost interface and minimal power consumption. In some embodiments, CBUS is a single-master bus used for functional register configuration (e.g., in contrast to a multi-master bus used in AHB and AXI). The single master device on the CBUS may be a processor.

Some implementations include a half-duplex bus advantageously using low bandwidth and having low power consumption. Other control bus architectures such as AXI use a full-duplex bus. A SINGLE transfer mode with at least one-cycle command and one-cycle data may be included in some embodiments; furthermore, the commands may use an un-pipelined bus protocol. In contrast, other control bus architectures, such as AXI and AHB, have a BURST mode and use pipelined protocols, in which a transfer is broken down into two or more phases that are executed one after the other. In some cases, CBUS may include fewer wires for reduced interface complexity. One embodiment of the CBUS, for example, uses 69 wires, versus 103 wires for AMBA 3 APB protocol, and 139 wires for AHB.

Examples of CBUS signals (prefixed with “c_”) are described in Table IV. Advantageously, the “c_addr_wdata” signal is created as a shared bus with write address, read address, and write data information. It increases wire usage efficiency and simplifies the hardware interconnection.

TABLE IV
32-Bit CBUS Signals

| Name | Source | Description |
|---|---|---|
| c_en | Micro-processor | When high it indicates that |
| | | the micro-processor sends |
| | | a CBUS command. |
| c_wr | Micro-processor | When high it indicates a write |
| | | transfer and when low a |
| | | read transfer. |
| c_addr_wdata[31:0] | Micro-processor | It indicates address at the |
| | | command stage, or write data |
| | | used to transfer data from |
| | | masters to slaves at the |
| | | write data stage. |
| c_rdata[31:0] | CBUS slaves | It is used to transfer data |
| | | from slaves to masters during |
| | | read operations. |
| c_vld | CBUS slaves | When high it indicates that |
| | | a data transfer has finished. |
| | | It may be driven low to |
| | | extend a transfer. |

Some embodiments of the subject invention include a CDBUS DMA (CDDMA). The CDDMA is the single slave device of the DBUS, controlling access to memory at the behest of one or more DBUS master devices.

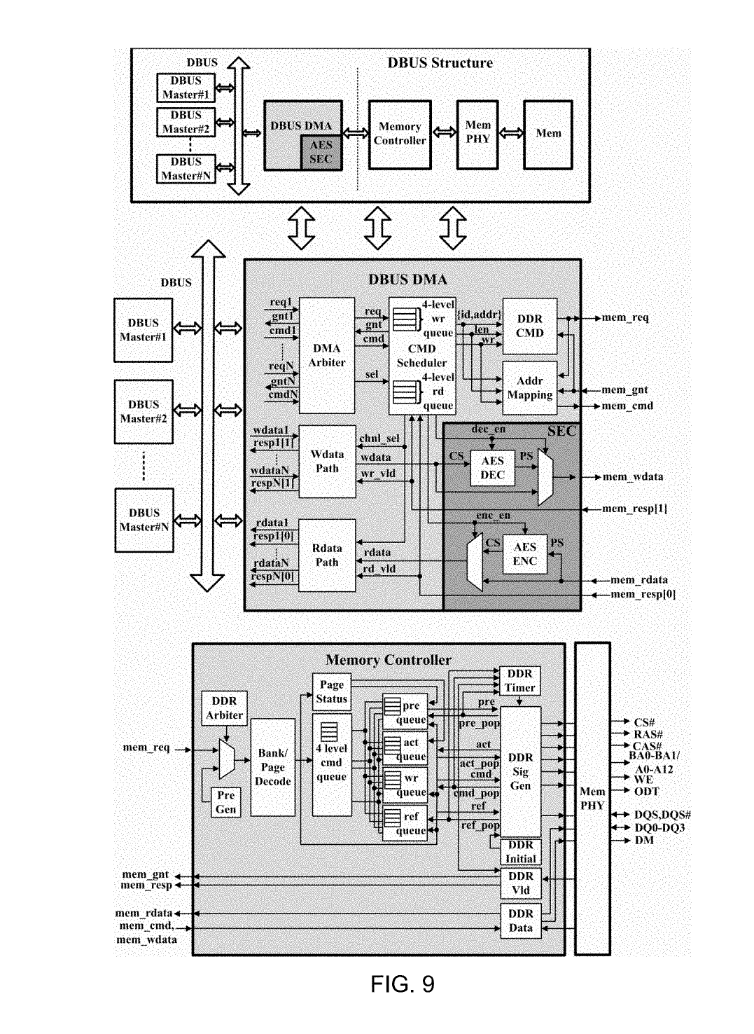

FIG. 9 shows an example component diagram depicting an overall DBUS structure, exemplary CDDMA structure, and interconnections with a memory controller and other memory system components. The DBUS structure shows DBUS master devices interconnected with CDDMA, which mediates access to memory controller. Expansion of the DBUS structure shown in grouping shows a detailed layout of components of the CDDMA, such as DMA arbiter, DDR CMD module, and the security component housing the AES ENC/DEC engines.

DBUS signals, e.g., as described with respect to Table II, are depicted on the CDDMA as directional arrows. Signals interchange between the CDDMA 1030 and the memory controller 1050 (a standard intellectual property core) are depicted as outbound and inbound signals, (e.g., mem_req, mem_gnt, mem_cmd, mem_wdata, mem_rdata, and mem_resp). The memory controller 1050 provides the control interface for external memory components 1051.

In some cases, as one of the CBUS slaves, the CDDMA is configured by the only master, which may be the micro-processor. Its functional registers include control, status, and round key registers. In addition, as the only slave of DBUS, the CDDMA can be accessed by all the masters located on DBUS. All the requests are granted sequentially according to each master's priority configured through CBUS. The CDDMA “arbiter” performs the function of deciding master priority by observing the different requests to use the bus and deciding which is currently the highest priority master requesting the bus. In the “CMD scheduler” of the CDDMA, all the bus requests can be preprocessed using the command queues. In the example CDDMA, since the queue level is four for both write and read, the maximum number of commands that can be pushed into the buffer is eight (four read and four write). After the memory interface is released, the commands are popped from the command queue, and then translated into memory commands by the memory command controller (“DDR CMD”) and the address mapping (“Addr mapping”) modules. The data path modules, write data path (“Wdata”) and read data path (“Rdata”), are used to multiplex cipher and non-cipher data processing between DBUS masters and memory. In non-cipher data transfers, e.g., the conventional linear and block transfers, the AES ENC/DEC engine is bypassed. In cipher data transfers, the write data path decrypts the ciphertexts via the DEC engine then writes the plaintexts into memory, or the read data path encrypts the plaintexts from memory via the ENC engine, then transfers the ciphertexts to the bus.

In certain embodiments, components of a computing device or system can be used in some implementations of techniques and systems for detecting and controlling time delays in an NCS as described herein. For example, any component of the system, including a controller (normal operation or local/emergency), time delay estimator, time delay detector, plant model, and transmitter may be implemented as described. Such a device can itself include one or more computing devices. The hardware can be configured according to any suitable computer architectures, such as a Symmetric Multi-Processing (SMP) architecture or a Non-Uniform Memory Access (NUMA) architecture. The device 1000 can include, for example, a processing system, which may include a processing device such as a central processing unit (CPU) or microprocessor and/or other circuitry that retrieves and executes software from a storage system. The processing system may be implemented within a single processing device but may also be distributed across multiple processing devices or sub-systems that cooperate in executing program instructions.

Examples of a processing system include general purpose central processing units, application specific processors, and logic devices, as well as any other type of processing device, combinations, or variations thereof. The one or more processing devices may include multiprocessors or multi-core processors and may operate according to one or more suitable instruction sets including, but not limited to, a Reduced Instruction Set Computing (RISC) instruction set, a Complex Instruction Set Computing (CISC) instruction set, or a combination thereof. In certain embodiments, one or more digital signal processors (DSPs) may be included as part of the computer hardware of the system in place of or in addition to a general purpose CPU.

A storage system may include any computer readable storage media readable by a processing system and capable of storing software, including, e.g., processing instructions for detecting, estimating, controlling, and/or adaptively controlling time delays in an NCS. A storage system may include volatile and nonvolatile, removable and non-removable media implemented in any method or technology for storage of information, such as computer readable instructions, data structures, program modules, or other data.

Examples of storage media include random access memory (RAM), read only memory (ROM), magnetic disks, optical disks, CDs, DVDs, flash memory, solid state memory, phase change memory, 3D-XPoint memory, or any other suitable storage media. Certain implementations may involve either or both virtual memory and non-virtual memory. In no case do storage media consist of a propagated signal. In addition to storage media, in some implementations, a storage system may also include communication media over which software may be communicated internally or externally.

A storage system may be implemented as a single storage device but may also be implemented across multiple storage devices or sub-systems co-located or distributed relative to each other. A storage system may include additional elements capable of communicating with a processing system.

Software may be implemented in program instructions and, among other functions, may, when executed by a computing device in general or processing system in particular, direct the device or processing system to operate as described herein for detecting, estimating, controlling, and/or adaptively controlling time delays in an NCS. Software may provide program instructions that implement components for detecting, estimating, controlling, and/or adaptively controlling time delays in an NCS. Software may implement on device components, programs, agents, or layers that implement in machine-readable processing instructions the methods and techniques described herein.

In general, software may, when loaded into a processing system and executed, transform a device overall from a general-purpose computing system into a special-purpose computing system customized to detect, estimate, control, and/or adaptively control time delays in an NCS in accordance with the techniques herein. Indeed, encoding software on a storage system may transform the physical structure of storage system. The specific transformation of the physical structure may depend on various factors in different implementations of this description. Examples of such factors may include, but are not limited to, the technology used to implement the storage media of a storage system and whether the computer-storage media are characterized as primary or secondary storage. Software may also include firmware or some other form of machine-readable processing instructions executable by a processing system. Software may also include additional processes, programs, or components, such as operating system software and other application software.

A device may represent any computing system on which software may be staged and from where software may be distributed, transported, downloaded, or otherwise provided to yet another computing system for deployment and execution, or yet additional distribution. A device may also represent other computing systems that may form a necessary or optional part of an operating environment for the disclosed techniques and systems, e.g., remote storage system or failure recovery server.

A communication interface may be included, providing communication connections and devices that allow for communication between a device and other computing systems over a communication network or collection of networks or the air. Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned communication media, network, connections, and devices are well known and need not be discussed at length here.

It should be noted that many elements of a device as described above may be included in a system-on-a-chip (SoC) device. These elements may include, but are not limited to, the processing system, a communications interface, and even elements of the storage system and software.

Alternatively, or in addition, the functionality, methods and processes described herein can be implemented, at least in part, by one or more hardware modules (or logic components). For example, the hardware modules can include, but are not limited to, application-specific integrated circuit (ASIC) chips, field programmable gate arrays (FPGAs), system-on-a-chip (SoC) systems, complex programmable logic devices (CPLDs) and other programmable logic devices now known or later developed. When the hardware modules are activated, the hardware modules perform the functionality, methods and processes included within the hardware modules.

The methods and processes described herein can be embodied as code and/or data. The software code and data described herein can be stored on one or more computer-readable media, which may include any device or medium that can store code and/or data for use by a computer system. When a computer system reads and executes the code and/or data stored on a computer-readable medium, the computer system performs the methods and processes embodied as data structures and code stored within the computer-readable storage medium.

It should be appreciated by those skilled in the art that computer-readable media include removable and non-removable structures/devices that can be used for storage of information, such as computer-readable instructions, data structures, program modules, and other data used by a computing system/environment. A computer-readable medium includes, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CDs, DVDs); network devices; or other media now known or later developed that is capable of storing computer-readable information/data. Computer-readable media should not be construed or interpreted to include any propagating signals. A computer-readable medium of the subject invention can be, for example, a compact disc (CD), digital video disc (DVD), flash memory device, volatile memory, or a hard disk drive (HDD), such as an external HDD or the HDD of a computing device, though embodiments are not limited thereto. A computing device can be, for example, a laptop computer, desktop computer, server, cell phone, or tablet, though embodiments are not limited thereto.

EXAMPLES/RESULTS/COMPUTATION: Following are examples that illustrate procedures for practicing certain disclosed techniques and/or implementing disclosed systems. Examples may also illustrate advantages, including technical effects, of the disclosed techniques and systems. These examples should not be construed as limiting.

In an example embodiment of the subject invention developed for comparison testing against the AXI DMA (ADMA) bus architecture, the 32-, 64-, and 128-bit ADMA and CDBUS DMA (CDDMA), along with AES encryption/decryption (ENV/DEC) engine, are designed using Verilog hardware description language (HDL). The AES system structure is shown in FIG. 1, and the CDDMA structure is shown in FIG. 9. These designs are used in experimental configurations in order to compare the power-area-throughput performance of AXI and CDBUS. A Universal Verification Methodology (UVM) environment is constructed to verify design-under-test (DUT) and evaluate transfer performance. Finally, the FPGA back-end flow is performed to estimate the area costs and power consumption.

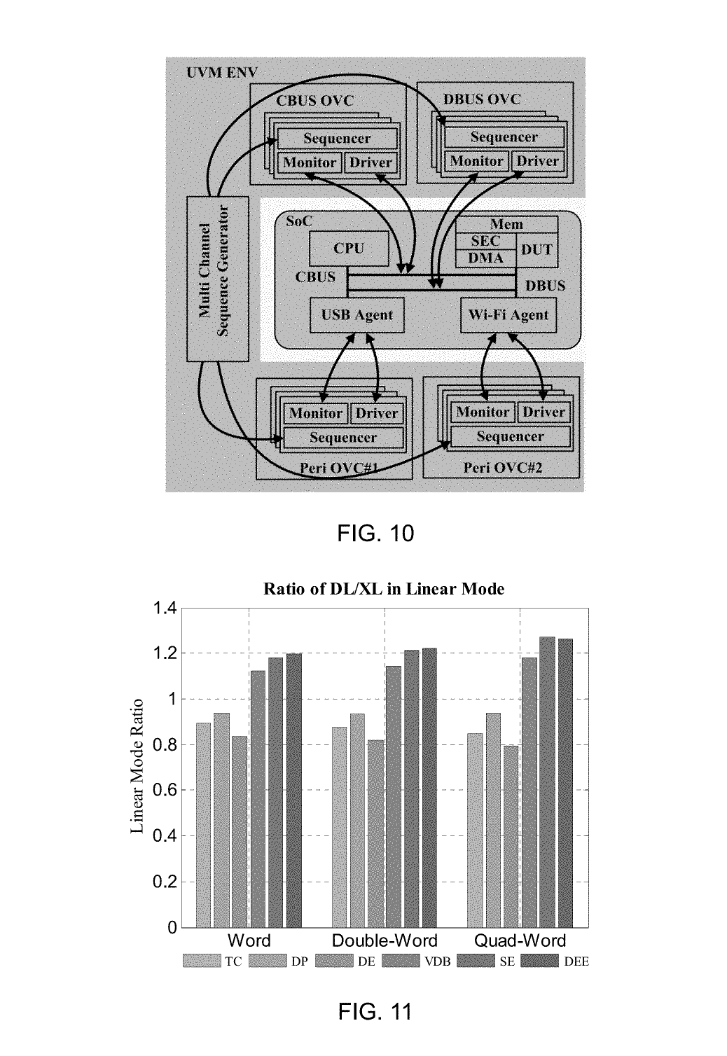

FIG. 10 shows an example UVM-based verification environment with a CDBUS architecture, CDDMA, and other components. FIG. 11 integrates four encapsulated, ready-to-use and configurable verification agents: the only master of CBUS denoted as CBUS OVC (micro-processor), the only slave of DBUS denoted as the DBUS OVC (Memory Controller), and two DBUS masters indicated as Peripheral OVC #1 (USB2.0 Host Controller) and Peripheral OVC #2 (Wi-Fi Mac) in the figure [30]. In the example, each OVC has three components: the sequencer, driver, and monitor. The driver is an active entity that emulates logic that drives the DUT environment; it repeatedly receives a data item and drives it to the DUT by sampling and driving DUT signals. The sequencer is an advanced stimulus generator that controls the items that are provided to the driver for execution. The monitor is a passive entity that samples, but does not drive, DUT signals; it collects coverage information and performs checking. The multi-channel sequence generator is a control center that synchronizes the OVC sequencers.

In typical test cases of this experimental environment, 40 words, 10×4 words, and 10 AES states are written into memory then read out, respectively, using linear, block, and state transfer modes. For the non-cipher tests, including linear and block cases, the ENC/DEC engine is bypassed by CDDMA and ADMA. Otherwise, the AES core is used to encrypt or decrypt data for the cipher tests. As an example, the USB2.0 agent initiates a 10-state write command to the data bus. The initial address is hexadecimal 0x00 and the data are ciphertext states. Then, CDDMA/ADMA responds to the request, decrypts the ciphertexts, and then writes the plaintexts into memory. After the first state is written into the memory, the Wi-Fi Mac agent requests a 10-state read operation to the same memory address immediately. Paralleling with the write operations, CDDMA/ADMA responds to the request, reads data out and encrypts the plaintexts to be ciphertexts, and then sends them on the data bus. During the data transfers, the control bus is responsible for initiating the AES round keys, controlling the DMA execution, handling the interrupts, and monitoring the bus status.

FPGA configurations may be used in some embodiments. For certain experimental implementations, different FPGA implementations are created for the 32-bit, 64-bit, and 128-bit CDDMA and ADMA. FPGA implementations have a full pipeline and maximum overlapping AES cores and are evaluated to identify the high-speed and low-power architectures for the embedded systems.

Procedurally, the 32-bit, 64-bit, and 128-bit ADMA and CDDMA are synthesized using a Xilinx ISE 14.7 with the target device Virtex6xc6vlx550t-2ff1760 [38]. Several fully-placed and routed NCD files and physical constraint PCF files are generated. Table V summarizes the number of IOs, resource utilization, and MOF for the different implementations. As shown in Table V, CDDMA uses fewer IO ports than ADMA for the identically-sized bus. Furthermore, the total number of occupied slices in the CDDMA designs are 24822 for the 32-bit bus, 21319 for the 64-bit bus, and 17060 for the 128-bit bus—fewer than the comparable ADMA designs. Moreover, the MOF of CDDMA is greater than ADMA for each of the 32-, 64-, and 128-bit buses.

Table VI shows the power statistics of the AXI- and CDBUS-based designs, obtained by inputting the NCD, PCF, and VCD files into the)(Power Analyzer tool. Since static power (SP) consumption is primarily determined by the circuit configuration, the static power of the same design is almost constant for different test cases. Therefore, analysis concentrates on dynamic power (DP).

First of all, it can be observed that the DBUS tests consume less dynamic power compared with AXI tests, because of the lower toggle rate of logic, signal, and IO (LSIO). In addition, the wider bus consumes more DP in all the block and cipher tests. In the linear tests, however, the 32-bit bus consumes more dynamic power than the 64-bit bus, because the LSIO switching rate is very low in these cases and the clock power becomes the dominant factor of the dynamic power consumption.

Table VII summarizes the experimental results as metrics CY, VDB, dynamic energy (DE), slice efficiency (SE), and dynamic energy efficiency (DEE).

TABLE V
Resource Comparison

| Resource Costs | IOs | Slices | MOF (MHz) |
|---|---|---|---|
| 32-bit ADMA | 533 | 26106 | 133.010 |
| 32-bit CDDMA | 324 | 24822 | 183.636 |
| 64-bit ADMA | 661 | 22603 | 131.528 |
| 64-bit CDDMA | 460 | 21319 | 176.154 |
| 128-bit ADMA | 917 | 18344 | 130.152 |
| 128-bit CDDMA | 732 | 17060 | 184.176 |

TABLE VI
Power Comparison

| | Static Power | Dynamic Power | Total Power |
|---|---|---|---|
| Test Cases | (mW) | (mW) | (mW) |
| 32-bit XL | 3799 | 612 | 4411 |
| 64-bit XL | 3796 | 577 | 4373 |
| 128-bit XL | 3797 | 623 | 4420 |
| 32-bit DL | 3796 | 574 | 4370 |
| 64-bit DL | 3794 | 540 | 4335 |
| 128-bit DL | 3796 | 584 | 4381 |
| 32-bit XB | 3801 | 752 | 4553 |
| 64-bit XB | 3812 | 971 | 4783 |
| 128-bit XB | 3826 | 1263 | 5089 |
| 32-bit DB | 3798 | 695 | 4493 |
| 64-bit DB | 3802 | 927 | 4729 |
| 128-bit DB | 3828 | 1226 | 5054 |
| 32-bit XC | 3805 | 771 | 4576 |
| 64-bit XC | 3818 | 1063 | 4881 |
| 128-bit XC | 3852 | 1747 | 5599 |
| 32-bit DC | 3802 | 716 | 4518 |
| 64-bit DC | 3816 | 995 | 4810 |
| 128-bit DC | 3847 | 1650 | 5497 |

TABLE VII
Experimental Result Comparison

| | | VDB | DE | SE | DEE |
|---|---|---|---|---|---|
| Test Cases | CY | (GBps) | (uJ) | (KBps/Slice) | (GBps/J) |
| 32-bit XL | 92.00 | 0.70 | 0.56 | 26.65 | 1.14 |
| 64-bit XL | 48.00 | 1.33 | 0.28 | 58.99 | 2.31 |
| 128-bit XL | 26.00 | 2.46 | 0.16 | 134.19 | 3.95 |
| 32-bit DL | 82.00 | 0.78 | 0.47 | 31.44 | 1.36 |
| 64-bit DL | 42.00 | 1.52 | 0.23 | 71.48 | 2.82 |
| 128-bit DL | 22.00 | 2.91 | 0.13 | 170.52 | 4.98 |
| 32-bit XB | 98.00 | 0.65 | 0.74 | 25.02 | 0.87 |
| 64-bit XB | 50.00 | 1.28 | 0.49 | 56.63 | 1.32 |
| 128-bit XB | 30.00 | 2.13 | 0.38 | 116.30 | 1.69 |
| 32-bit DB | 82.00 | 0.78 | 0.57 | 31.44 | 1.12 |
| 64-bit DB | 42.00 | 1.52 | 0.39 | 71.48 | 1.64 |
| 128-bit DB | 22.00 | 2.91 | 0.27 | 170.52 | 2.37 |
| 32-bit XC | 172.00 | 0.37 | 1.33 | 14.25 | 0.48 |
| 64-bit XC | 112.00 | 0.57 | 1.19 | 25.28 | 0.54 |
| 128-bit XC | 82.00 | 0.78 | 1.43 | 42.55 | 0.45 |
| 32-bit DC | 132.00 | 0.48 | 0.95 | 19.53 | 0.68 |
| 64-bit DC | 72.00 | 0.89 | 0.72 | 41.69 | 0.89 |
| 128-bit DC | 42.00 | 1.52 | 0.69 | 89.32 | 0.92 |

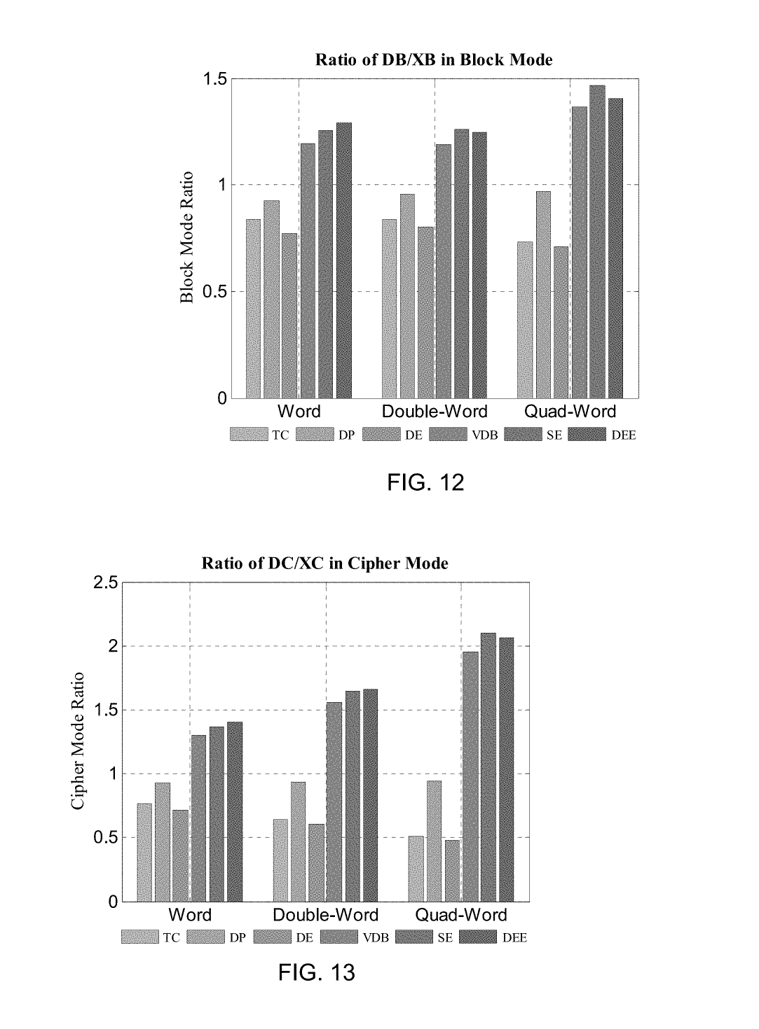

In the practical tests, read commands follow write commands to verify the memory accessing correctness. Thus, the read and write transfers are not completely overlapped. FIG. 11 and FIG. 12 show the non-cipher test ratios, DL/XL and DB/XB, of all the performance metrics. Since all the time consumption (TC) ratios are less than 1, DBUS consumes less time than the AXI for all the three bus sizes' implementations. Particularly for the block tests, the latency of DBUS are 83.67%, 84.00%, and 73.33%, respectively, compared with AXI for all the 32-, 64-, and 128-bit buses. Additionally, the dynamic energy, which is the integral of dynamic power, or the product of average dynamic power and transfer time, is considered. Although the dynamic power consumed by CDDMA and XDMA are close to each other, the dynamic energy consumption of DL tests are 83.60%, 81.89%, and 79.32%, respectively, compared with the XL tests, and the dynamic energy consumption of DB tests are 77.33%, 80.19%, and 71.19%, respectively, compared with the XB tests, for all the 32-, 64-, and 128-bit bus implementations. Furthermore, based on the fair assumption of the same operational clock frequencies for DBUS and AXI, the conventional bandwidth between full-duplex DBUS and AXI are the same. However, the valid data bandwidth of DBUS surpasses AXI due to the high performance structure. For example, the valid data bandwidth of DL test is 1.18 times of XL test, and the valid data bandwidth of DB test can reach 1.36 times of XB test, when the bus size is 128 bits.

In order to evaluate the area-efficiency, slice efficiency is also computed in terms of valid data number that can be transferred per second per slice. It can be observed that the slice efficiency of DL test is 1.27 times of XL test, and the slice efficiency of DB test is 1.47 times compared with XB test when the bus size is 128 bits. Then, dynamic energy efficiency is further defined in terms of valid data number that can be transferred per second per watt, or valid data number that can be transferred per joule. The dynamic energy efficiency of DL test can reach 1.26 times compared with XL test, and the dynamic energy efficiency of DB test can reach 1.40 times of XB test when the bus size is 128 bits. In other words, DBUS can transfer 1.40 times as much data as AXI with the same time and power consumption in this case.

Then, we focus on comparing the cipher test performance shown in FIG. 13. Using the high-efficiency state transfer mode for the AES-encrypted circuits, the DC tests achieve higher performance than the AXI tests. First, the time spent by DC tests are 76.74%, 64.29%, and 51.22%, respectively, compared with XC tests for 32-, 64-, and 128-bit buses. Second, the dynamic energy consumed by the DC tests are 71.27%, 60.17%, and 48.38% compared with the XC tests for the 32-, 64-, and 128-bit buses, respectively, although the dynamic power of DC tests and XC tests are very close to each other. Third, the conventional bandwidth and valid data bandwidth of the DC transfers can reach 2.95 GBps and 1.52 GBps, respectively, on the 128-bit DBUS. The DC/XC valid data bandwidth ratios are 1.30, 1.56, and 1.95, respectively, when the bus size is 32, 64, and 128 bits. Finally, we consider the slice efficiency and dynamic energy efficiency of all the AXI and DBUS tests. The 128-bit DC test can transfer 89.32 Kbytes per second per slice cost. As the highest slice efficiency of all the cipher tests, it is 2.10 times compared with the 128-bit XC test. Additionally, the dynamic energy efficiency of the DC tests are 1.40, 1.66, and 2.07 times compared with the XC tests for the 32-, 64-, and 128-bit buses, respectively. It indicates that DBUS can transfer 2.07 times as much data as AXI with the same time and power consumption when bus sizes are 128 bits.

Embodiments of the subject invention including the CDBUS protocol, block and AES state transfer modes, and optimized bus structure surpass the performance of AXI in a variety of metrics. Furthermore, the 128-bit implementations cost more IOs and dynamic power, but achieves a higher slice and dynamic energy efficiency than 32- and 64-bit buses, for all the linear, block, and cipher transfer tests. Considering the design requirements and resource limitations, designers can choose different bus sizes based implementations.

It should be understood that the examples and embodiments described herein are for illustrative purposes only and that various modifications or changes in light thereof will be suggested to persons skilled in the art and are to be included within the spirit and purview of this application.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

All patents, patent applications, provisional applications, and publications referred to or cited herein (including those in the “References” section) are incorporated by reference in their entirety, including all figures and tables, to the extent they are not inconsistent with the explicit teachings of this specification.

### REFERENCES

[1] Advanced Encryption Standard (AES), FIPS-197, Nat. Inst. Of Standards and Technol., November 2001.
[2] T. Good and M. Benaissa, “692-nW Advanced Encryption Standard (AES) on a 0.13-um CMOS,” IEEE Trans. Very Large Scale Integr. (VLSI) Syst., Vol. 18, No. 12, pp. 1753-1757, December 2010.
[3] Y. Wang and Y Ha, “FPGA-Based 40.9-Gbits/s Masked AES with Area Optimization for Storage Area Network,” IEEE Trans. Circuits Syst. II. Exp. Briefs, Vol. 60, No. 1, pp. 36-40, January 2013.
[4] N. Mentens, L. Batinan, B. Preneeland, and I. Verbauwhede, “A Systematic Evaluation of Compact Hardware Implementation for the Rijndael S-Box,” in Proc. Topics Cryptology (CT-RSA), Vol. 3376/2005, pp 323-333, 2005.
[5] V. Fischer and M. Drutarovsky, “Two methods of Rijndael implementation in reconfigurable hardware,” in Proc. CHES 2001, Paris, France, May 2001, pp. 77-92.
[6] M. McLoone and J. V. McCanny, “Rijndael FPGA implementation utilizing look-up tables,” IEEE
Workshop on Signal Processing Systems, September 2001, pp. 349-360.
[7] K. Stevens, O. A. Mohamed, “Single-Chip FPGA Implementation of a Pipelined, Memory-Based AES,” Canadian Conference on Electrical and Computer Engineering, pp 1296-1299, 2005.
[8] V. Rijmen, “Efficient Implementation of the Rijndael S-box,” 2000. [Online]. Available: http://ftp.comms.scitech.susx.ac.uk/fft/crypto/rijndael-sbox.pdf.
[9] X. Zhang and K. K. Parhi, “High-Speed VLSI Architecture for the AES Algorithm,” IEEE Trans. Very Large Scale Integr. (VLSI) Syst., Vol. 12, No. 9, pp. 957-967, September 2004.
[10] D. Canright, “A Very Compact Rijnael S-Box,” Naval Postgraduate School, Monterey, Calif., Teach. Rep. NPS-MA-04-001, 2005.
[11] E. N C Mui, “Practical Implementation of Rijndael S-Box Using Combinational Logic,” Custom R&D Engineer Texco Enterprise Pvt. Ltd., 2007.
[12] J. Wolkerstorfer, E. Oswald, and M. Lamberger, “An ASIC implementation of the AES 5-boxes,” in proc. ASICRYPT, pp. 239-245, December 2000.
[13] A. Satoh, S. Morioka, K. Takano, and S. Munetoh, “A Compact Rijndael Hardware Architecture with S-Box Optimization,” in Proc. ASIACRYPT, December 2000, pp. 239-245.
[14] X. Zhang and K. K. Parhi, “On the optimum constructions of composite field for the AES algorithm,” IEEE Trans. Circuits Syst. II. Exp. Briefs, Vol. 53, No. 10, pp. 1153-1157, October 2006.
[15] M. M. Wong, M. L. D. Wong, A. K. Nandi, and I. Hijazin, “Construction of Optimum Composite Field Architecture for Compact High-Throughput AES S-Boxes,” IEEE Trans. Very Large Scale Integr. (VLSI) Syst., Vol. 20, No. 6, pp. 1151-1155, June 2012.
[16] C. Hsing Wang, C. Lin Chuang, and C. Wen Wu, “An Efficient Multimode Multiplier Supporting AES and Fundamental Operations of Public-Key Cryptosystems,” IEEE Trans. Very Large Scale Integr. (VLSI) Syst., Vol. 18, No. 4, pp. 553-563, April 2010.
[17] S. Fu Hsiao, M. Chih Chen, and C. Shin Tu, “Memory-Free Low-Cost Designs of Advanced Encryption Standard Using Common Subexpression Elimination for Subfunctions in Transformations,” IEEE Trans. Circuits Syst. I, Reg. Papers, Vol. 53, No. 3, March 2006.
[18] M. Mozaffari-Kermaniand AReyhani-Masoleh, “Efficient and High-Performance Parallel Hardware Architectures for the AES-GCM,” IEEE Trans. Comput., Vol. 61, No. 8, pp. 1165-1178, August 2012.
[19] N. Sklavos and O. Koufopavlou, “Architectures and VLSI Implementations of the AES-Proposal Rijndael,” IEEE Trans. Comput., Vol. 51, No. 12, pp. 1454-1459, December 2012.
[20] A. Hodjat and I. Verbauwhede, “Area-Throughput Trade-Offs for Fully Pipelined 30 to 70 Gbits/s AES processors,” IEEE Trans. Comput., Vol. 55, No. 4, pp. 366-372, April 2006.
[21] W. Suntiamorntut, W. Wittayapanpracha, “The Study of AES Encryption for Wireless FPGA Node,” International Journal of Communications in Information Science and Management Engineering, Vol. 2, No. 3, pp. 40-46, March 2012.
[22] AMBA Specification, Axis. Sunnyvale, Calif., USA, 1999.
[23] AMBA AXI Protocol Specification,” Axis. Sunnyvale, Calif., USA, 2003.
[24] Wishbone BUS, Silicore Corp., Corcoran, Minn., USA, 2003.
[25] Open Core Protocol Specification, OCP Int. Partnership, Beaverton, Oreg., USA, 2001.
[26] CoreConnect Bus Architecture, IBM. Yorktown Heights, N.Y., USA, 1999.
[27] STBus Interconnect, STMicroelectronics. Geneva, Switzerland, 2004.
[28] X. Yang, J. Andrian, “A High Performance On-Chip Bus (MSBUS) Design and Verification,” IEEE Trans. Very Large Scale Integr. (VLSI) Syst. (TVLSI), Vol. 23, Issue: 7, PP. 1350-1354, July 2014.
[29] X. Yang, J. Andrian, “A Low-Cost and High-Performance Embedded System Architecture and An Evaluation Methodology,” IEEE Computer Society Annual Symposium on VLSI (ISVLSI 2015), March 2014, pp. 240-243
[30] X. Yang, N. Wu, J. Andrian, “A Novel Bus Transfer Mode: Block Transfer and A Performance Evaluation Methodology,” Elsevier, Integration, the VLSI Journal, Vol. 52, PP. 23-33, January 2016, Available: DOI:10.1016/j.vlsi.2015.07.012
[31] C. Paar, “Efficient VLSI architecture for bit-parallel computations in Galois field,” Ph.D. dissertation, Institute for Experimental Mathematics, University of Essen, Essen, Germany, 1994.
[32] IEEE Standard Verilog Hardware Description Language, The Institute of Electrical and Electronics Engineers, Inc., 3 Park Ave., NY, USA, September, 2001.
[33] R. C. Gonzalez, R. E. Woods, “Digital Image Processing,” 3rd ed., Prentice Hall Publisher, June, 2012, pp. 68-99.
[34] “IEEE Std 802.11,” Rev. of IEEE Std 802.11-1999.
[35] “MPEG-2 Standards, Part1 Systems,” June 2010.
[36] Accellera, UVM 1.1 Reference Manual, June 2011.
[37] Accellera, UVM 1.1 User Guide, May. 2012.
[38] Xilinx, Virtex-6 Family Overview, January 2012.

What is claimed is:

1. A device, comprising:
a control bus having a single master; and
a data bus, in operable communication with the control bus, having a single slave providing connectivity between the single master of the control bus, memory, and an encryption/decryption engine.

2. The device according to claim 1, wherein the single master is a microprocessor.

3. The device according to claim 2, wherein the encryption/decryption engine is an AES encryption/decryption engine.

4. The device according to claim 1, wherein the encryption/decryption engine is an AES encryption/decryption engine.

5. The device according to claim 1, wherein the single slave is a direct memory access (DMA) slave.

6. The device according to claim 5, wherein the single slave is a DMA controller.

7. The device according to claim 6, wherein the single slave is an Advanced Encryption Standard (AES)-centric DMA controller.

8. The device according to claim 5, wherein the DMA slave performs dynamic request arbitration, command pre-processing, and handling of multiple transfer modes.

9. The device according to claim 8, wherein the single master is a microprocessor.

10. The device according to claim 9, wherein the encryption/decryption engine is an AES encryption/decryption engine.

11. A system on a chip (SoC), comprising the device according to claim 10 and at least one peripheral device.

12. The SoC according to claim 11, wherein the SoC further comprises at least one control module, and wherein the control bus connects all peripheral devices of the SoC and all control modules of the SoC.

13. The SoC according to claim 12, wherein the DMA slave controls which master has access to the data bus and operates the data transfers between the master of the control bus and the memory.

14. The device according to claim 5, wherein the DMA slave controls which master has access to the data bus and operates the data transfers between the master of the control bus and the memory.

15. The device according to claim 1, wherein the control bus is configured to connect peripheral devices of an SoC to control modules of the SoC.

16. A method of performing data transfer, the method comprising:
adopting an Advanced Encryption Standard (AES) state as the basic unit of data transfer;
processing state data during the transfer in column-major order;
performing a READ operation into an encryption engine by cyclic-shift of the plaintext state data; and
performing a WRITE operation into a decryption engine by cyclic-inverse-shift of the ciphtertext state data.

17. A system for performing data transfer, the system comprising a computer-readable storage medium having program instructions stored thereon, which, when executed by a processing system, direct the processing system to perform the method according to claim 16.
